(19) United States
(12) Patent Application Publication
(10) Pub. No.: US 2015/0302485 A1
(43) Pub. Date: Oct. 22, 2015

(54) ON-SITE SALES PRESENTATION SYSTEM

(71) Applicants: Nicholas Aaron Mortenson, Buffalo, MN (US); Molly Marie Mortenson, Buffalo, MN (US)

(72) Inventors: Nicholas Aaron Mortenson, Buffalo, MN (US); Molly Marie Mortenson, Buffalo, MN (US)

(21) Appl. No.: 14/753,700

(22) Filed: Jun. 29, 2015

Related U.S. Application Data
(63) Continuation of application No. 14/269,067, filed on May 2, 2014.
(60) Provisional application No. 61/968,950, filed on Mar. 21, 2014.

(51) Int. Cl. G06Q 30/02; G06Q 50/08

(52) U.S. Cl. CPC G06Q 30/0269; G06Q 30/0276; G06Q 50/08

(57) ABSTRACT

An on-site construction sales presentation system assists salespersons in delivering construction sales presentations to target customers with mobile computing devices at customers' sites. The system operates to prompt a salesperson to take at least one photograph of a subject building located at a site through the camera module, capture the at least one photograph of the subject building, generate a customized sales presentation to assist the salesperson in making the customized sales presentation to a target customer, and present the sales presentation to the target customer.

### CROSS-REFERENCE TO RELATED APPLICATION

This application claims priority to U.S. Ser. No. 14/269,067, titled ON-SITE SALES PRESENTATION SYSTEM, filed May 2, 2014 which claims priority to U.S. Ser. No. 61/968,950, titled ON-SITE SALES PRESENTATION SYSTEM, filed on Mar. 21, 2014. The disclosures of U.S. Ser. No. 14/269,067 and U.S. Ser. No. 61/968,950 are each hereby incorporated by reference in its entirety.

### BACKGROUND

Sales presentations are planned presentation of a product or service designed to initiate a sale of the product or service. Sales presentations are typically designed to be either an introduction of a product or service to potential customers who have little knowledge of the product or service, or a descriptive expansion of the product or service to target customers who have already expressed interest in the product or service. Companies typically prepare sales presentation materials that assist their sales representatives in delivering the sales presentation of a product or service to potential or existing customers.

### SUMMARY

In general terms, this disclosure is directed to an on-site sales presentation system. In one possible configuration and by non-limiting example, the on-site sales presentation system is configured to assist salespersons in delivering construction sales presentations to target customers with mobile computing devices at customers' site. Various aspects are described in this disclosure, which include, but are not limited to, the following aspects.

One aspect is a system for performing an on-site construction sales presentation, the system comprising: a processing device configured to control operation of the system; a camera module; and a computer readable data storage device storing software instructions that, when executed by the processing device, cause the system to: prompt a salesperson to take at least one photograph of a subject building through the camera module, the subject building located at a site; capture the at least one photograph of the subject building; generate a customized sales presentation to assist the salesperson in making the customized sales presentation to a target customer, the customized sales presentation including sales information and at least some of the at least one photographs of the subject building; and present the sales presentation to the target customer.

Another aspect is a method for performing an on-site construction sales presentation with a mobile device, the method comprising: prompting a salesperson to take at least one photograph of a subject building through the camera module, the subject building located at a site; capturing the at least one photograph of the subject building; generating a customized sales presentation to assist the salesperson in making the customized sales presentation to a target customer, the customized sales presentation including sales information and at least some of the at least one photographs of the subject building; and presenting the sales presentation to the target customer.

Yet another aspect is a system for performing an on-site construction sales presentation, the system comprising: a processing device configured to control operation of the system; an input device; a display screen; a camera module; and a computer readable data storage device storing software instructions that, when executed by the processing device, cause the system to: execute a presentation set-up engine to: display options of a first photograph type and a second photograph type; receive a user selection of the first photograph type through the input device; execute the camera module to interact with the salesperson to take a first photograph, the first photograph including a subject building located at a site; capture the first photograph; and display a preview of the first photograph on the display screen, and execute a presentation engine to: generate a customized sales presentation to assist the salesperson in presenting the customized sales presentation to a target customer at the site, the customized sales presentation including sales information and the first photograph; assign the first photograph to a first predetermined portion of the customized sales presentation; display options of building materials applicable to the subject building; receive a user selection of one of the options of building materials; modify the first photograph to demonstrate the subject building with the selected option of building materials; disable a second predetermined portion of the customized sales presentation when a second photograph representative of the second photograph type is not captured, the second predetermined portion of the customized sales presentation being assigned for the second photograph representative of the second photograph type; and receive a user request for navigating through the sales presentation.

### BRIEF DESCRIPTION OF THE DRAWINGS

FIG. 1 illustrates an exemplary embodiment of a construction sales presentation system at a customer site.

FIG. 2 illustrates an exemplary method of performing an on-site sales presentation with a mobile computing device.

FIG. 3 illustrates an exemplary architecture of the mobile computing device.

FIG. 4 illustrates an exemplary on-site sales presentation engine.

FIG. 5 illustrates an example sales presentation main control screen.

FIG. 6 illustrates an example presentation setup engine.

FIG. 7 illustrates an example user interface for executing a salesperson management engine.

FIG. 8 illustrates an example salesperson edit screen.

FIG. 9 illustrates an example salesperson introduction screen.

FIG. 10 illustrates an example user interface for executing a customer management engine.

FIG. 11 illustrates an example subject building edit screen.

FIG. 12 illustrates an example customer addition screen.

FIG. 13 illustrates the customer addition screen of FIG. 12 with a virtual keyboard to permit a salesperson to input information on a new customer.

FIG. 14 illustrates an example main control screen that shows the new customer added in the customer addition screen.

FIG. 15 is a flowchart illustrating an example method of operating a photograph capture engine.

FIG. 16 is a flowchart illustrating an example method of prompting the salesperson to take photographs of a subject building at the customer site.

FIG. 17 illustrates an example user interface for executing a photograph capture engine.

FIG. 18 illustrates an example photograph-taking screen.

FIG. 19 illustrates the photograph-taking screen of FIG. 18 with photographs of different types taken with a camera module.

FIG. 20 illustrates the main control screen updated with at least some of the photographs taken by the salesperson at the photograph-taking screen.

FIG. 21 illustrates an example presentation engine.

FIG. 22 illustrates an example customized sales presentation.

FIG. 23 illustrates an example table of contents of the sales presentation.

FIG. 24 illustrates the table of contents of FIG. 23.

FIG. 25 illustrates an example subject building presentation screen.

FIG. 26 illustrates an example overview screen.

FIG. 27 illustrates an example roofing screen.

FIG. 28 illustrates an example siding screen.

FIG. 29 illustrates an example gutter system screen.

FIG. 30 illustrates an example windows screen.

FIG. 31 illustrates an example warranty screen.

FIG. 32 illustrates an example insurance claim work screen.

FIG. 33 illustrates another example promotion screen.

FIG. 34 illustrates yet another promotion screen with video clips.

FIG. 35 a flowchart illustrating a method of operating a design demonstration engine.

FIG. 36 illustrates the main control screen with a selectable control for the design demonstration engine.

FIG. 37 illustrates an example design demonstration screen.

FIG. 38 illustrates an example design option screen.

FIG. 39 illustrates an example design option sub-screen.

FIG. 40 illustrates an example design application screen.

FIG. 41 illustrates the design application screen with a second visual indicator.

FIG. 42 illustrates the design application screen with a third visual indicator.

FIG. 43 illustrates the design application screen with a fourth visual indicator.

FIG. 44 illustrates the design application screen with the fourth visual indicator displaced to a new location.

FIG. 45 illustrates the design application screen with a first parameter of a building material design adjusted.

FIG. 46 illustrates the design application screen with the first parameter of the building material design adjusted.

FIG. 47 illustrates the design application screen with a second parameter of the building material design adjusted.

FIG. 48 illustrates the design application screen with a second parameter of the building material design adjusted.

FIG. 49 illustrates the design application screen with a third parameter of the building material design adjusted.

FIG. 50 illustrates the design application screen with a third parameter of the building material design adjusted.

FIG. 51 illustrates the design demonstration screen with another building material design.

FIG. 52 illustrates an example network communication system of the on-site sales presentation system.

FIG. 53 illustrates an example server communication engine.

FIG. 54 illustrates the main control screen with selectable controls for operating a data transfer engine.

FIG. 55 illustrates an example application branding engine.

FIG. 56 illustrates the main control screen with a branding control.

FIG. 57 illustrates an example branding screen.

FIG. 58 illustrates the main control screen with a different theme and company name/logo.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

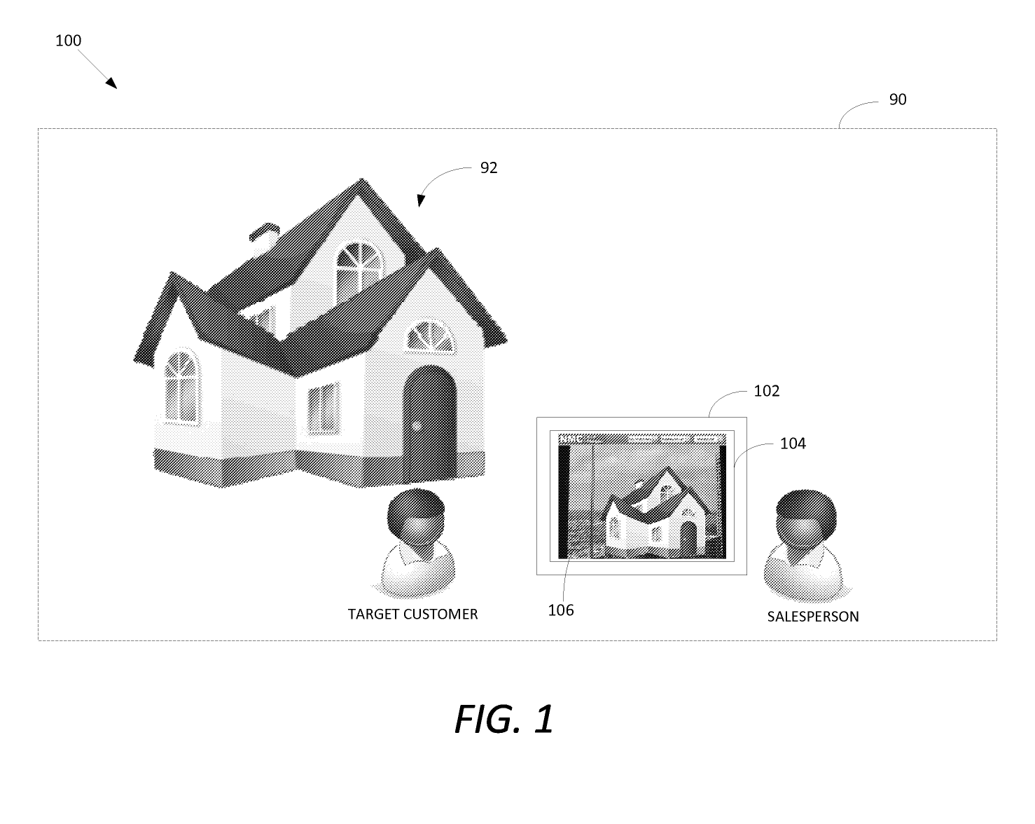

FIG. 1 illustrates an exemplary embodiment of a construction sales presentation system 100 at a customer site 90. In some examples, the system 100 includes a mobile computing device 102, an on-site sales presentation engine 104, and a customized sales presentation 106.

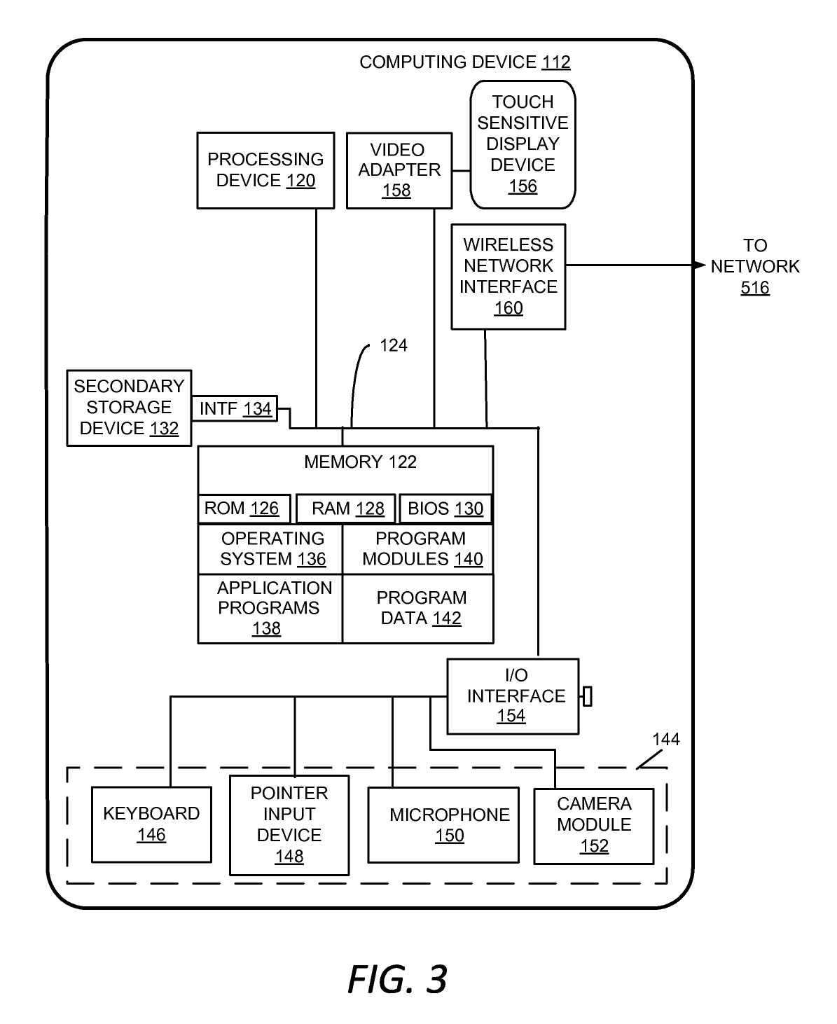

The mobile computing device 102 operates to execute the on-site sales presentation engine 104 to assist a salesperson in giving the customized sales presentation 106 to a target customer. The mobile computing device 102 is operated by the salesperson. As explained below, in some embodiments, the mobile computing device 102 is a smart phone, a tablet computer (e.g., an iPad® mobile digital device), an iPod® mobile digital device, a laptop computer, or other mobile devices. Example configurations of the mobile computing device 102 are described in further detail with reference to FIG. 3.

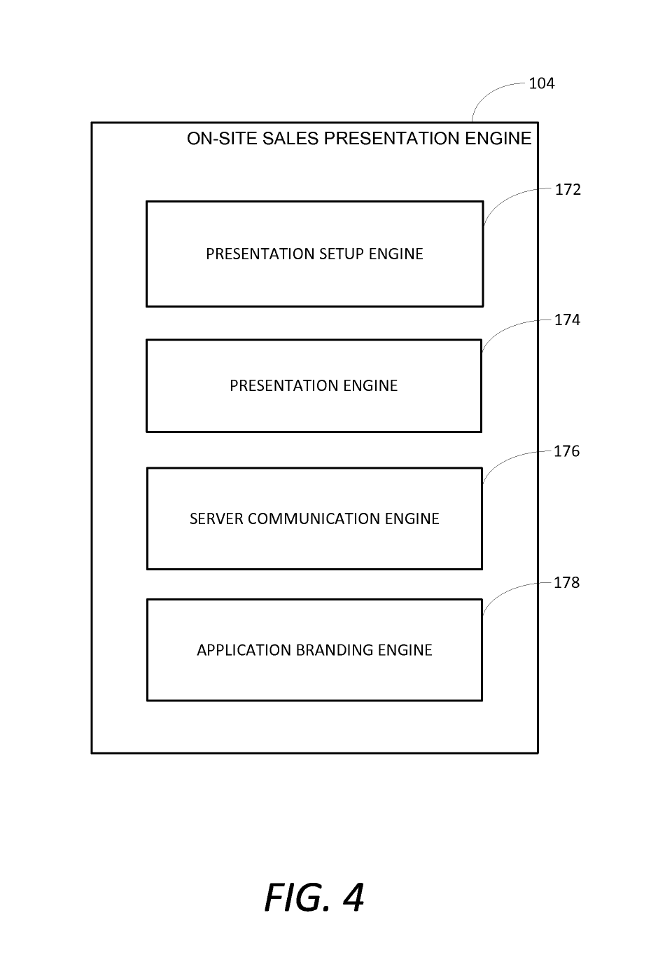

The on-site sales presentation engine 104 runs on the mobile computing device 102 and operates to generate and present the customized sales presentation 106 on the mobile computing device 102. Examples of the on-site sales presentation engine 104 are described in further detail with reference to FIG. 4.

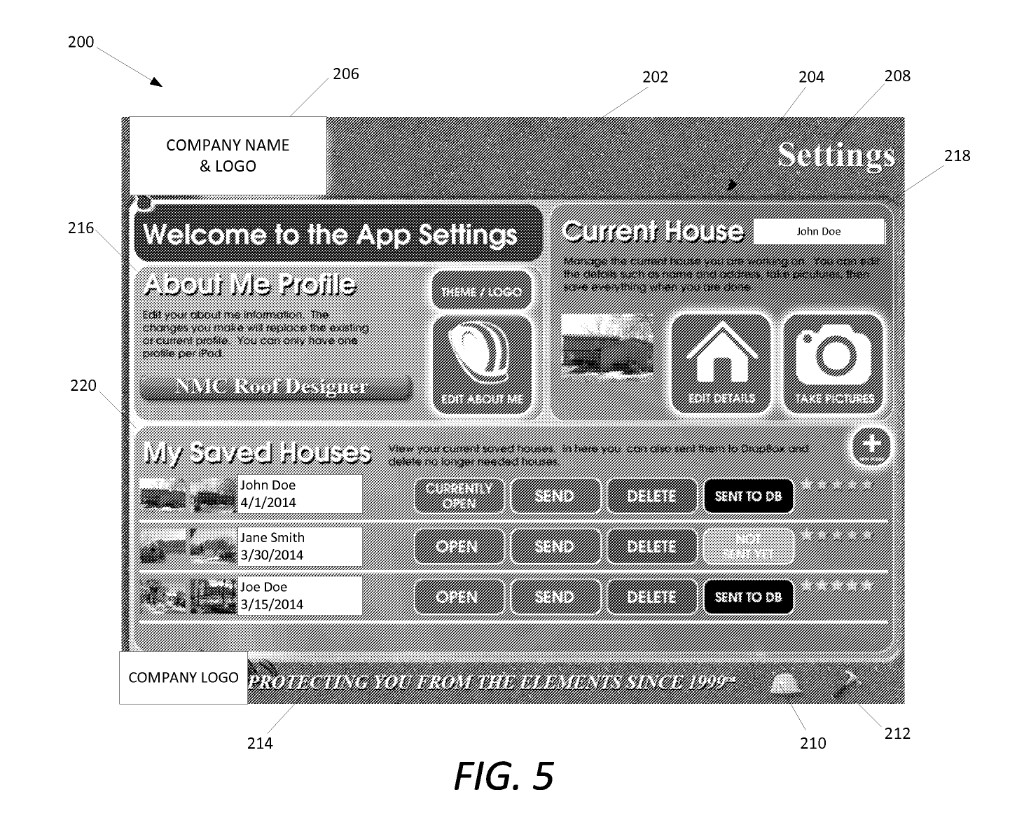

The customized sales presentation 106 is displayed on the mobile computing device 102 by the operation of the on-site sales presentation engine 104. In some embodiments, the customized sales presentation 106 includes construction sales presentation materials that are customized for a particular target customer. As described below, in some embodiments, the customized sales presentation 106 includes a variety of sales information and one or more photographs of a subject building 92 at the customer site 90. Examples of the customized sales presentation 106 are described in further detail with reference to FIGS. 5-58.

The subject building 92 is a structure of any type that is the subject of the customized sales presentation 106 and potential construction works, such as roofing, siding, and window replacement. Examples of the subject building 92 include residential, commercial, industrial, educational, government, military, religious, and transport buildings, and any other types of buildings (any type of home or house, such as single home, town home, multi-family property). In this document, the subject building is also referred to as a house or home.

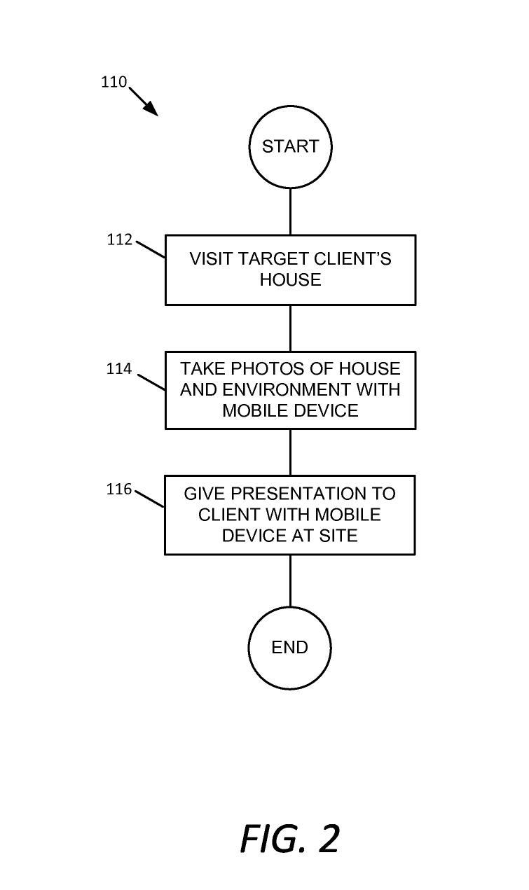

FIG. 2 illustrates an exemplary method 110 of performing the on-site sales presentation 106 with the mobile computing device 102. In some embodiments, the method 110 includes operations 112, 114 and 116.

In some embodiments, the construction sales presentation system 100 is used for generating and providing a sales presentation to target customers, such as homeowners, property owners, or residents, at their sites. For example, the system 100 provides a presentation tool to show the target customers areas of the subject buildings that they are interested in changing, restoring, or building.

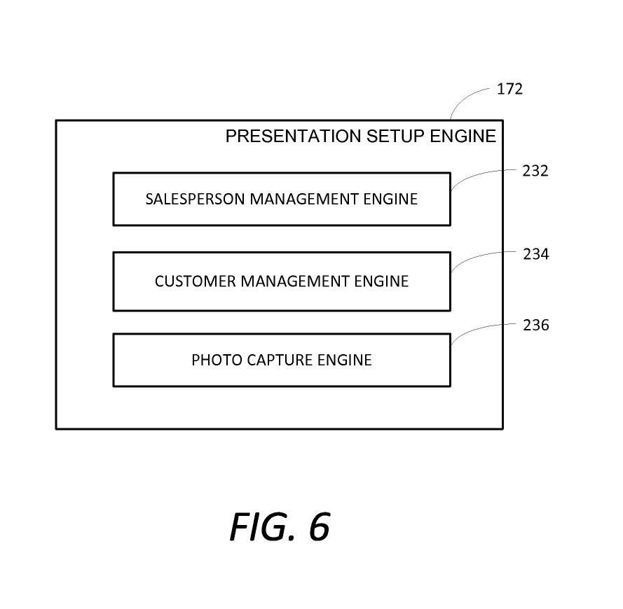

At the operation 112, the salesperson visits the target customer at the customer site 90, on which the subject building 92 is located. In some embodiments, the salesperson controls the mobile computing device 102 to execute a salesperson management engine 232 (FIG. 6) that presents salesperson information on the mobile computing device 102. The salesperson information presented on the mobile computing device 102 provides introductory information on the salesperson to the target customer.

At the operation 114, the salesperson takes one or more photographs of the subject building 92 and the surroundings with the mobile computing device 102. For example, the salesperson can walk around the customer site 90 to assess the customer site 90 including the subject building 92, such as the target customer's house or lot, and the surrounding area around the subject building 92. The salesperson then takes one or more photographs of the customer site 90 for the customized sales presentation 106. In some examples, the salesperson obtains permission from the target customer before walking around the customer site 90 and taking the photographs thereof. In some embodiments, the salesperson can enter information associated with the target customer and/or the site 90 including the subject building 92 into the mobile computing device 102 for the customized sales presentation 106.

At the operation 116, the salesperson returns to the target customer and presents the customized sales presentation 106 to the target customer with the mobile computing device 102. The customized sales presentation 106 is generated and presented by the on-site sales presentation engine 104 and used to demonstrate work to be done to the site 90 and/or the subject building 92. As described below, the customized sales presentation 106 includes a variety of sales information and at least some of the photographs taken at the operation 114.

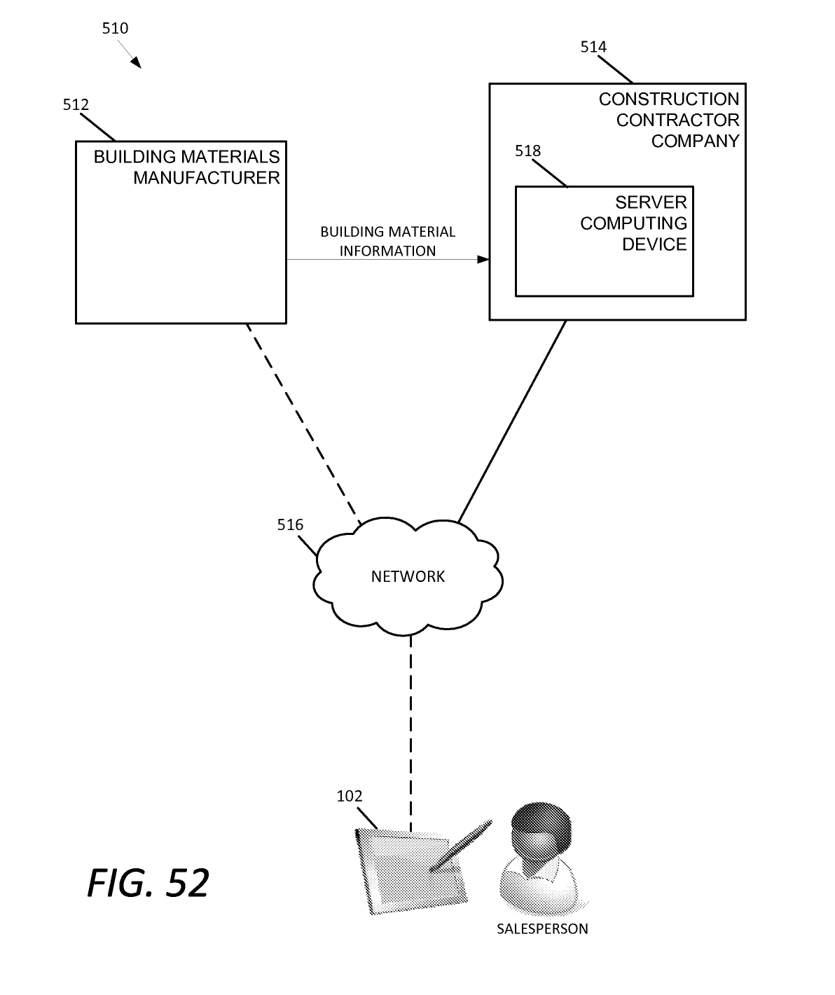

In some embodiments, the method 110 is performed without connection to a server computing device 518 of the construction contractor company 514 (FIG. 52) via a data communication network 516 (FIG. 52). As described in further detail with reference to FIGS. 52-54, the mobile computing device 102 need not always be connected to the network 516 because the mobile computing device 102 contains information necessary for the sales presentation 106 at the customer site 90. Such information is managed by the server computing device 518 when the mobile computing device 102 is connected to the server computing device 518 through the network 516 (FIG. 52).

FIG. 3 illustrates an exemplary architecture of the mobile computing device 102 that can be used to implement aspects of the present disclosure. The architecture shown in FIG. 3 can also be an example of other computing devices, such as a server computing device 518 (FIG. 52), as described below. One or more computing devices, such as the type illustrated in FIG. 3, are used to execute the operating system, application programs, and software modules (including the software engines) described herein.

The mobile computing device 102 includes, in some embodiments, at least one processing device 120, such as a central processing unit (CPU). A variety of processing devices are available from a variety of manufacturers, for example, Intel or Advanced Micro Devices. In this example, the mobile computing device 102 also includes a system memory 122, and a system bus 124 that couples various system components including the system memory 122 to the processing device 120. The system bus 124 is one of any number of types of bus structures including a memory bus or memory controller, a peripheral bus, and a local bus using any of a variety of bus architectures.

Examples of computing devices suitable for the mobile computing device 102 include a smart phone, a tablet computer (e.g., an iPad® mobile digital device), an iPod® mobile digital device, a laptop computer, or other mobile devices configured to process digital instructions.

The system memory 122 includes read only memory 126 and random access memory 128. A basic input/output system 130 containing the basic routines that act to transfer information within mobile computing device 102, such as during start up, is typically stored in the read only memory 126.

The mobile computing device 102 also includes a secondary storage device 132 in some embodiments, such as a hard disk drive, for storing digital data. The secondary storage device 132 is connected to the system bus 124 by a secondary storage interface 134. The secondary storage devices 132 and their associated computer readable media provide nonvolatile storage of computer readable instructions (including application programs and program modules), data structures, and other data for the mobile computing device 102.

Although the exemplary environment described herein employs a hard disk drive as a secondary storage device, other types of computer readable storage media are used in other embodiments. Examples of these other types of computer readable storage media include magnetic cassettes, flash memory or other solid state memory technology, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in a secondary storage device 132 or a memory 122, including an operating system 136, one or more application programs 138, other program modules 140 (such as the software engines described herein), and program data 142. The mobile computing device 102 can utilize any suitable operating system, such as Microsoft Windows™, Google Chrome™, Apple OS, and any other operating system suitable for a computing device. The data used by the mobile computing device 102 may be stored at any location in the memory 122, such as the program data 142, or at the secondary storage device 132.

In some embodiments, a user provides inputs to the mobile computing device 102 through one or more input devices 144. Examples of input devices 144 include a keyboard 146, a pointer input device 148, a microphone 150, a camera module 152, and a touch-sensitive display device 156. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices 144 and interface 154 is possible as well, and includes infrared, BLUETOOTH® wireless technology, 802.11a/b/g/n, cellular or other radio frequency communication systems in some possible embodiments.

In this example embodiment, a touch-sensitive display device 156 is also connected to the system bus 184 via an interface, such as a video adapter 158. The touch sensitive display device 156 includes touch sensors for receiving input from a user when the user touches the display or, in some embodiments, or gets close to touching the display. Such sensors can be capacitive sensors, pressure sensors, optical sensors, or other touch sensors. The sensors not only detect contact with the display, but also the location of the contact and movement of the contact over time. For example, a user can move a finger or stylus across the screen or near the screen to provide written inputs. The written inputs are evaluated and, in some embodiments, converted into text inputs.

In addition to the display device 156, the mobile computing device 102 can include various other peripheral devices (not shown), such as speakers or a printer.

When used in a local area networking environment or a wide area networking environment (such as the Internet), the mobile computing device 102 is typically connected to the network through a network interface, such as a wireless network interface 160. Other possible embodiments use other communication devices. For example, some embodiments of the mobile computing device 102 include an Ethernet network interface, or a modem for communicating across the network.

The mobile computing device 102 typically includes at least some form of computer-readable media. Computer readable media includes any available media that can be accessed by the mobile computing device 102. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the mobile computing device 102. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 3 is also an example of programmable electronics, which may include one or more such computing devices, and when multiple computing devices are included, such computing devices can be coupled together with a suitable data communication network so as to collectively perform the various functions, methods, or operations disclosed herein.

FIG. 4 illustrates an exemplary on-site sales presentation engine 104. In some embodiments, the on-site sales presentation engine 104 includes a presentation setup engine 172, a presentation engine 174, a server communication engine 176, and an application branding engine 178.

The presentation setup engine 172 operates to perform setup operations in order to prepare the customized sales presentation 106. Examples of the presentation setup engine 172 are illustrated and described in more detail with reference to FIGS. 6-20.

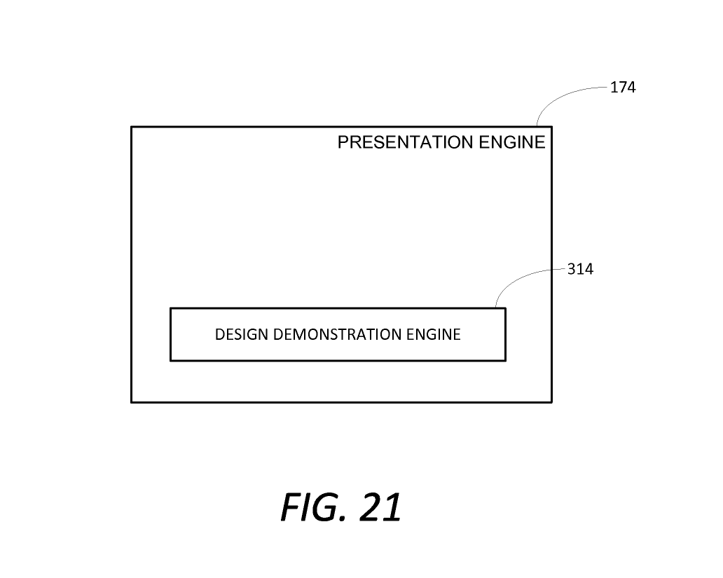

The presentation engine 174 operates to generate and present the customized sales presentation 106 on the mobile computing device 102. Examples of the presentation engine 174 are illustrated and described in further detail with reference to FIGS. 21-51.

The server communication engine 176 executes communication between the mobile computing device 102 and the server computing device 518, which is operated by the construction contractor company 514, via a data communication network 516 for various purposes (FIG. 52). Examples of the server communication engine 176 are illustrated and described in further detail with reference to FIGS. 52-54.

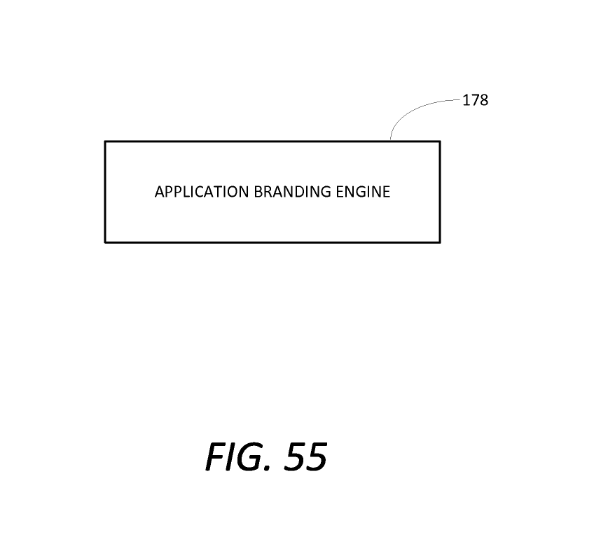

In some embodiments, the on-site sales presentation engine 104 is configured to be used by salespersons or representatives of multiple different companies. Accordingly, some embodiments include the application branding engine 178, which operates to permit the customized sales presentation 106 to be branded for the particular company. Branding can include, for example, the importing and arrangement of a company name and/or log into the customized sales presentations 106, and adjustment of the color scheme or other ornamental features of the customized sales presentation 106. Examples of the application branding engine 178 are illustrated and described in further detail with reference to FIGS. 55-58.

FIG. 5 illustrates an example sales presentation main control screen 200. The mobile computing device 102 displays the main control screen 200 while the on-site sales presentation engine 104 runs on the mobile computing device 102. In some examples, the main control screen 200 includes a template frame 202 and an information display frame 204. In some examples, the template frame 202 includes a company identifier 206, a screen title 208, a salesperson introduction control 210, a home return control 212, and an additional information region 214. The information display frame 204 includes a user management region 216, a subject building management region 218, and a customer management region 220.

The template frame 202 provides a background of the main control screen 200. In some examples, the template frame 202 remains substantially the same while the information display frame 204 displays different information.

The information display frame 204 provides an area for displaying different information or data, as well as sales information including photographs for the customized sales presentation 106, as described below.

In some examples, the company identifier 206 is arranged in the template frame 202 to identify a construction contractor company to which the salesperson who gives the customized sales presentation 106 belongs. In some embodiments, the company identifier 206 can also be used as a selectable control for initiating the customized sales presentation 106.

The screen title 208 is arranged in the template frame 202 to identify the characteristics of the information or data displayed on the information display frame 204. In the depicted example of FIG. 5, the screen title 208 is “Settings” to indicate that the main control screen 200 is generated in the information display frame 204. As shown below, other names or titles are assigned to the screen title 208 for different information displayed in the information display frame 204.

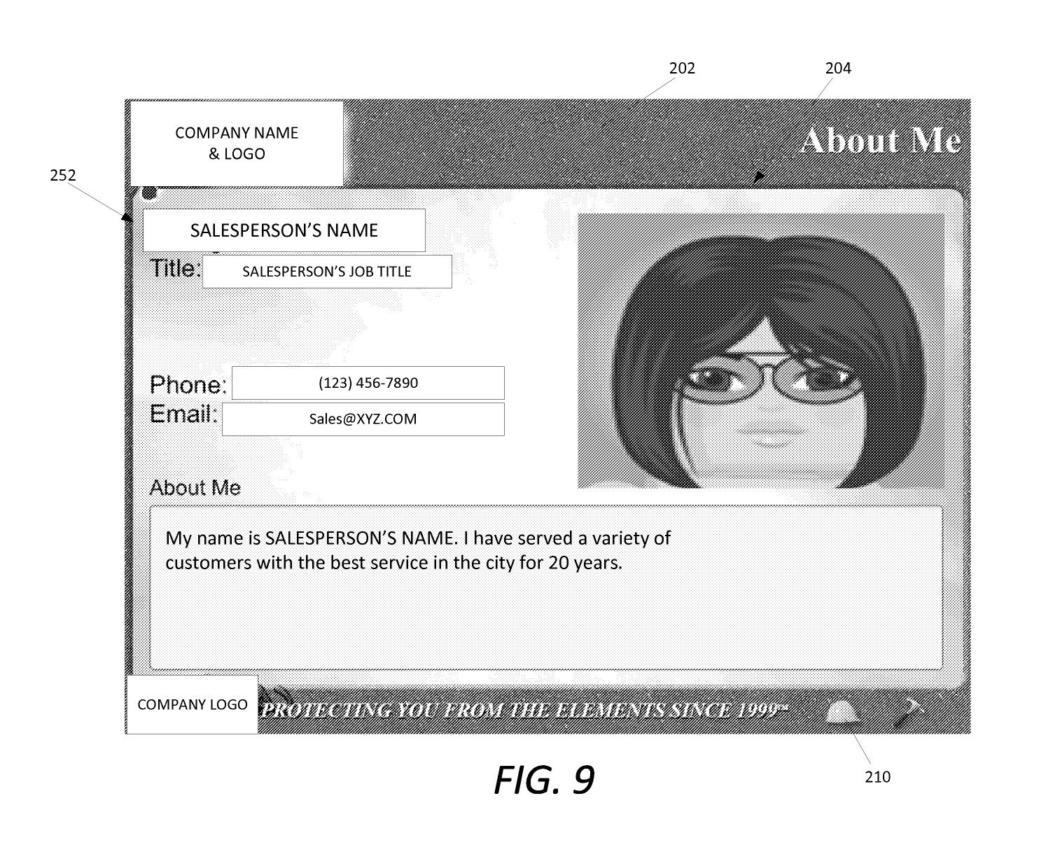

The salesperson introduction control 210 is linked to a salesperson introduction screen 252 (FIG. 9). Thus, when the salesperson selects the salesperson introduction control 210, the mobile computing device 102 initiates the salesperson introduction screen 252 and displays the salesperson introduction within the information display frame 204. In some examples, the salesperson introduction control 210 is arranged on the bottom area of the template frame 202 and is always displayed when the on-site sales presentation engine 104 runs on the mobile computing device 102, thereby allowing the salesperson to open the salesperson introduction screen 252 any time during the customized sales presentation 106.

The home return control 212 is configured to permit the salesperson to navigate to the main control screen 200. In some embodiments, the home return control 212 is arranged on the bottom area of the template frame 202 and is always displayed when the on-site sales presentation engine 104 runs on the mobile computing device 102, thereby allowing the salesperson to open the main control screen 200 any time during the customized sales presentation 106.

In some examples, the template frame 202 includes the additional information region 214 configured to present any type of information. In the depicted example, the additional information region 214 includes a company's symbol and description, such as a motto.

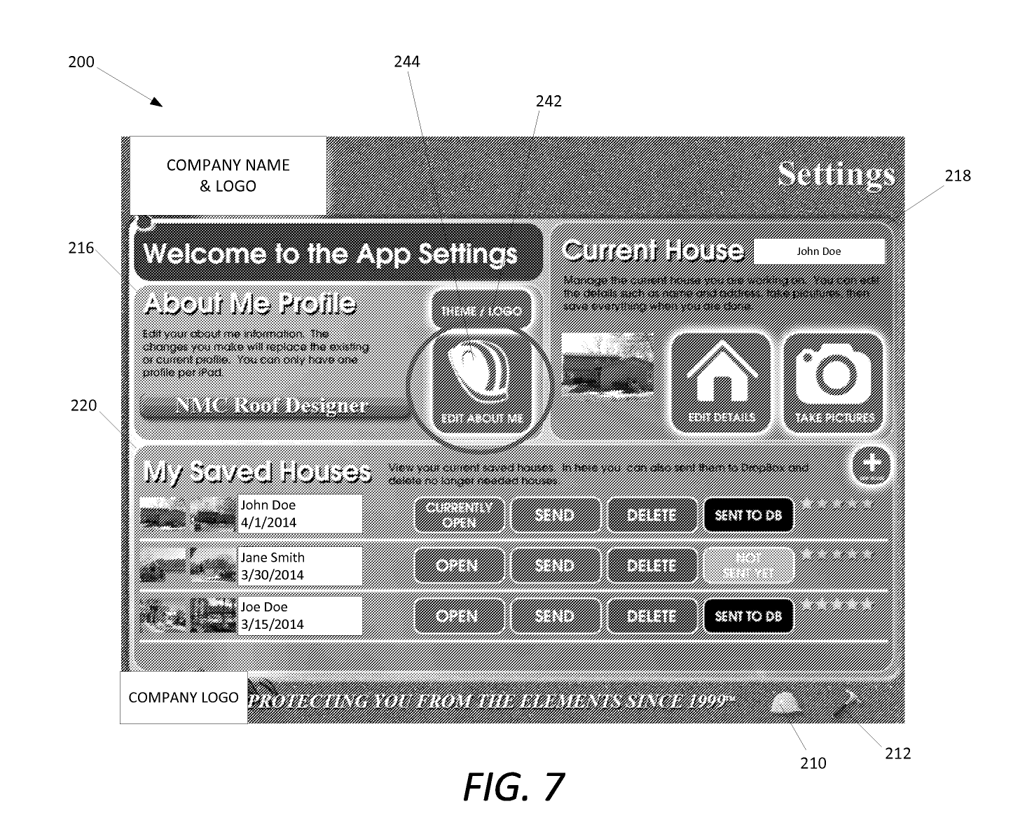

The user management region 216 provides one or more controls that the salesperson can select to navigate to different screens configured to manage the salesperson information and the layout information of the customized sales presentation 106. In some embodiments, the user management region 216 includes several selectable controls to initiate different engines and/or screens. Examples of the selectable controls are illustrated and described in further detail with reference to FIGS. 7, 36, and 56.

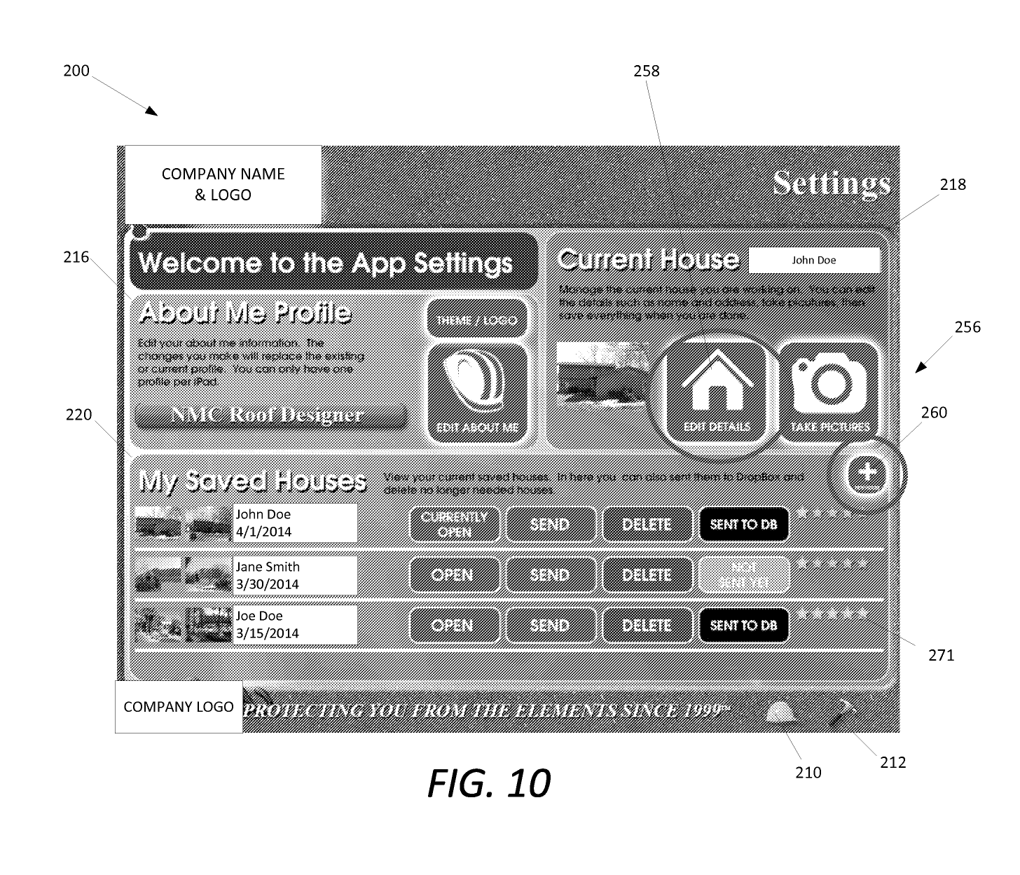

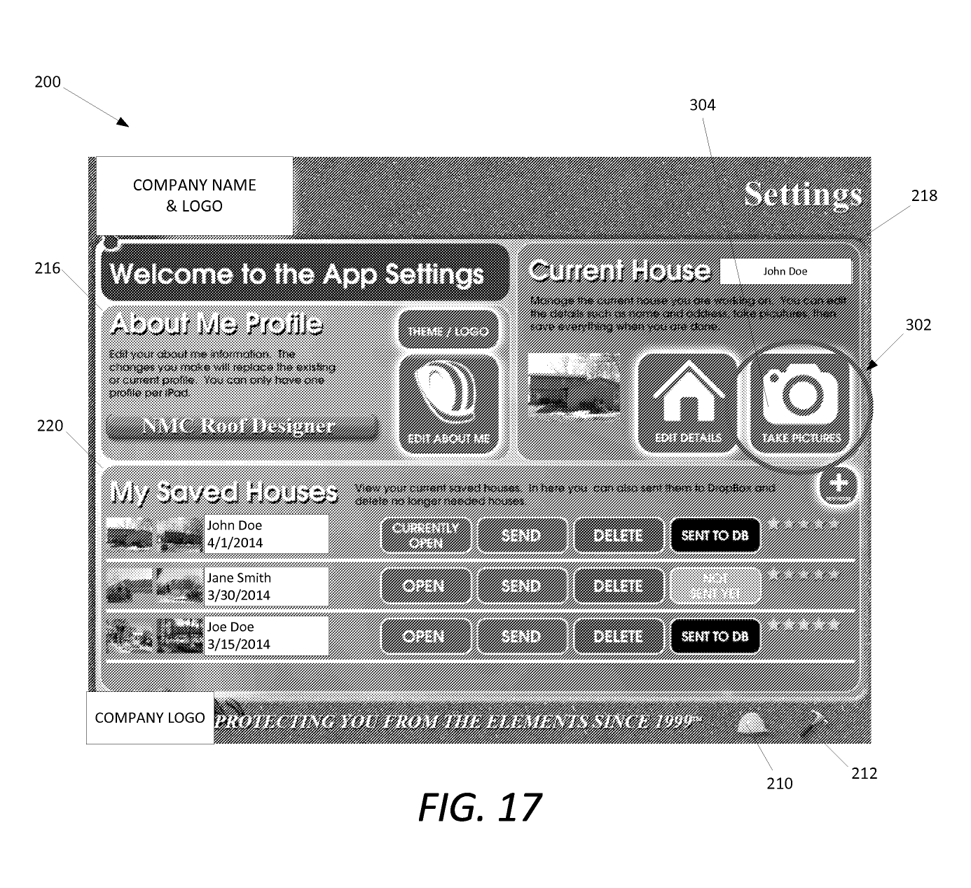

The subject building management region 218 operates to display the subject building that the salesperson is currently working on for the customized sales presentation 106. In addition, the subject building management region 218 provides one or more controls that the salesperson can select to navigate to different screens configured to manage the information on the subject building and/or capture photographs of the subject building. Examples of such controls arranged in the subject building management region 218 are illustrated and described in further detail with reference to FIGS. 10 and 17.

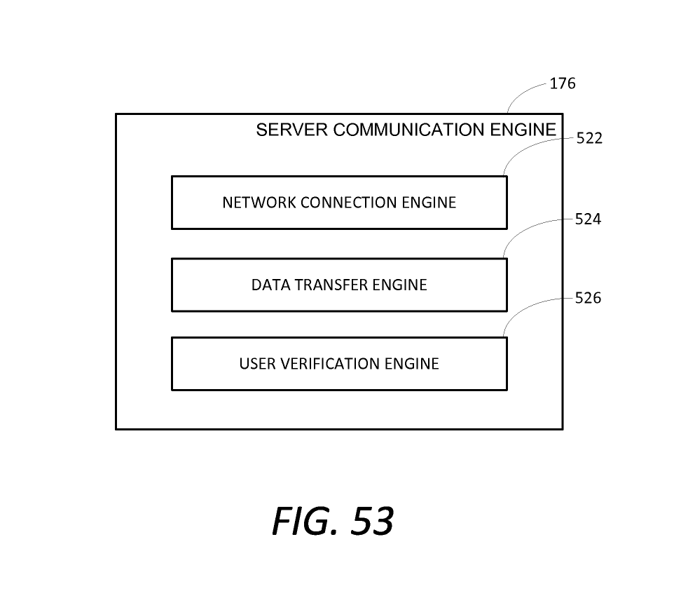

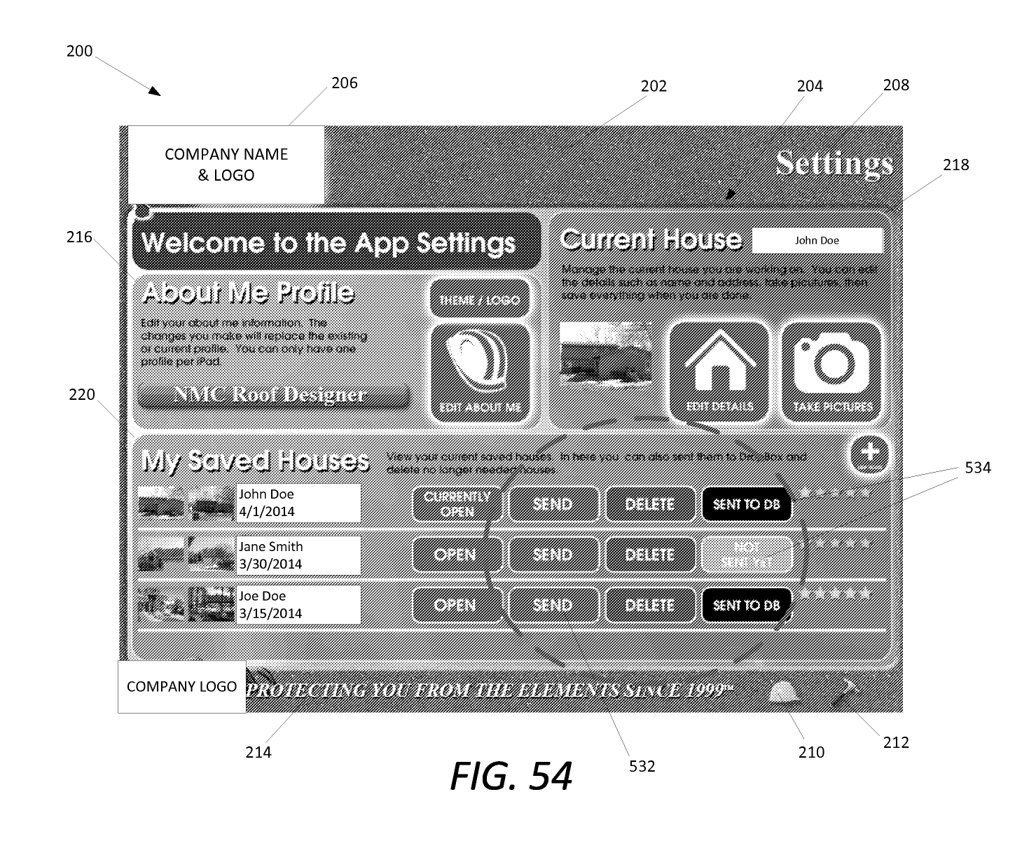

The customer management region 220 operates to display a list of existing or potential customers. The customer management region 220 provides one or more controls that the salesperson can select to open another customer for the customized sales presentation 106, and/or to manage customer information stored in the mobile computing device 102. Examples of such controls arranged in the customer management region 220 are illustrated and described in further detail with reference to FIGS. 53 and 54.

FIG. 6 illustrates an example presentation setup engine 172. In some embodiments, the presentation setup engine 172 includes a salesperson management engine 232, a customer management engine 234, and a photograph capture engine 236.

The salesperson management engine 232 operates to add or update information on the salesperson who manipulates the mobile computing device 102 for the customized sales presentation 106. An example operation of the salesperson management engine 232 is illustrated and described below with reference of FIGS. 7-9.

The customer management engine 234 operates to add or update information on the subject building for the customized sales presentation 106. An example operation of the customer management engine 234 is illustrated and described with reference to FIGS. 10-14.

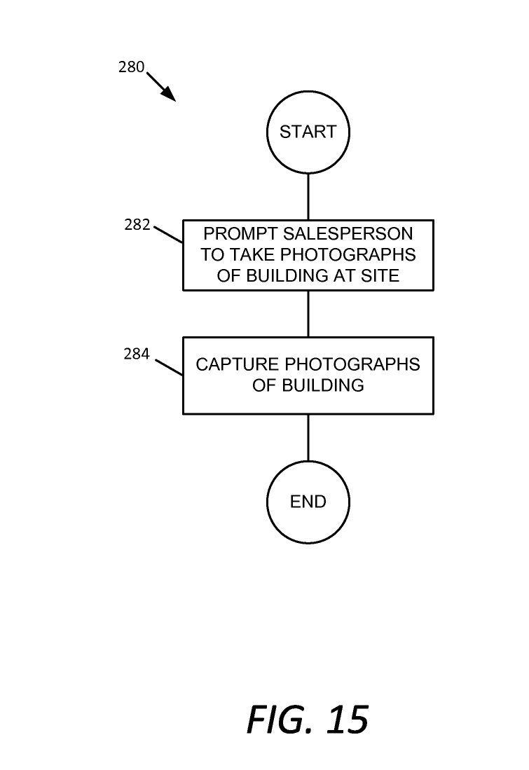

The photograph capture engine 236 operates to prompt the salesperson to take one or more photographs of the subject building 92 at the customer site 90 and capture the photographs of the site 90. At least some of the photographs of the subject building 92 are used is the customized sales presentation 106. An example operation of the photograph capture engine 236 is illustrated and described below with reference to FIGS. 15-20.

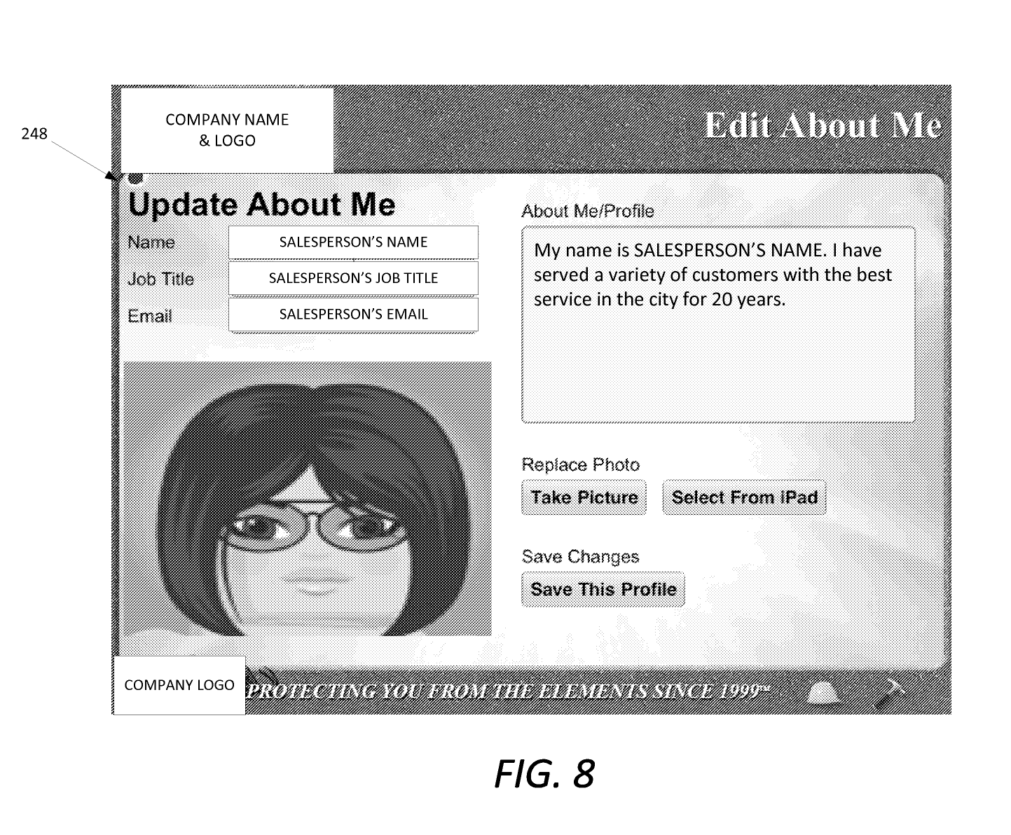

FIG. 7 illustrates an example user interface 242 for the salesperson to execute the salesperson management engine 232. In some embodiments, the user interface 242 includes a salesperson edit control 244 arranged within the user management region 216. When the salesperson selects the salesperson edit control 244, the salesperson management engine 232 generates and displays a salesperson edit screen 248 (FIG. 8) that permits the salesperson to add or update the information on the salesperson.

The salesperson selects the salesperson edit control 244 through the input device 144 of the mobile computing device 102. As discussed above, the input device 144 can be of any type. In the depicted example, the mobile computing device 102 includes the touch-sensitive display 156 that operates as both a display screen and an input device.

FIG. 8 illustrates an example salesperson edit screen 248. In some embodiments, the salesperson edit screen 248 provides text boxes that allow the salesperson to input information on the salesperson, and selectable controls that allow the salesperson to navigate to take a photograph of the salesperson or select a photograph stored in the mobile computing device 102. Such salesperson information includes, for example, the salesperson's name, contact information (telephone number, email address, etc.), job title, and photograph. The salesperson can also input additional description or profile of the salesperson in a predetermined text box. Once the update is done and the salesperson selects a save control for storing the update, the salesperson management engine 232 operates to store the updated information about the salesperson in the mobile computing device 102 and returns to the main control screen 200.

FIG. 9 illustrates an example salesperson introduction screen 252. In some embodiments, the salesperson introduction screen 252 displays the salesperson information that has been input by the salesperson in the salesperson edit screen 248.

As described above, the salesperson introduction control 210 is provided on the template frame 202 for permitting the salesperson to navigate into the salesperson introduction screen 252. When the salesperson selects the salesperson introduction control 210, the salesperson management engine 232 operates to display the salesperson introduction screen 252 within the information display frame 204. As described above, in some examples, the salesperson introduction control 210 is arranged on the template frame 202, which is always displayed on the display device 156. Thus, the salesperson can always easily navigate the salesperson introduction screen 252 by selecting the salesperson introduction control 210 during the customized sales presentation 106.

FIG. 10 illustrates an example user interface 256 for the salesperson to execute the customer management engine 234. In some embodiments, the user interface 256 includes a subject building edit control 258 and a new customer addition control 260.

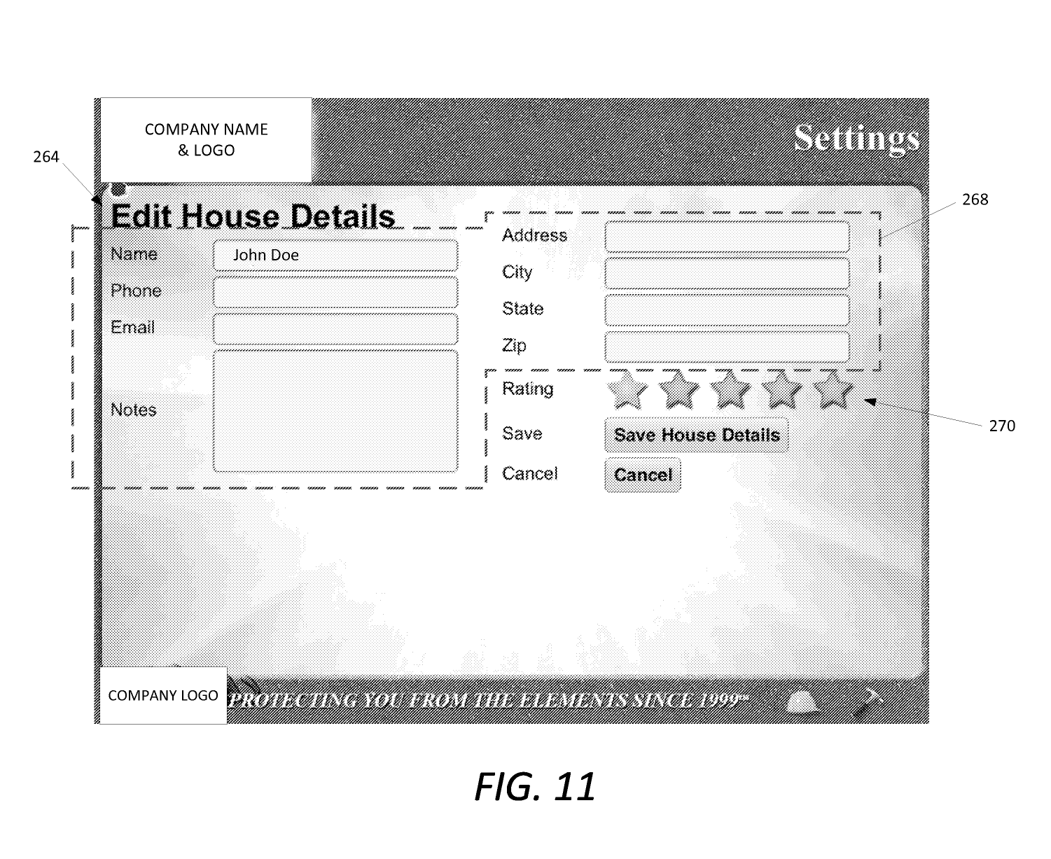

In some embodiments, the subject building edit control 258 is arranged within the subject building management region 218. When the salesperson selects the subject building edit control 258, the customer management engine 234 generates and displays a subject building edit screen 264 (FIG. 11) that permits the salesperson to revise or update the information on the subject building 92.

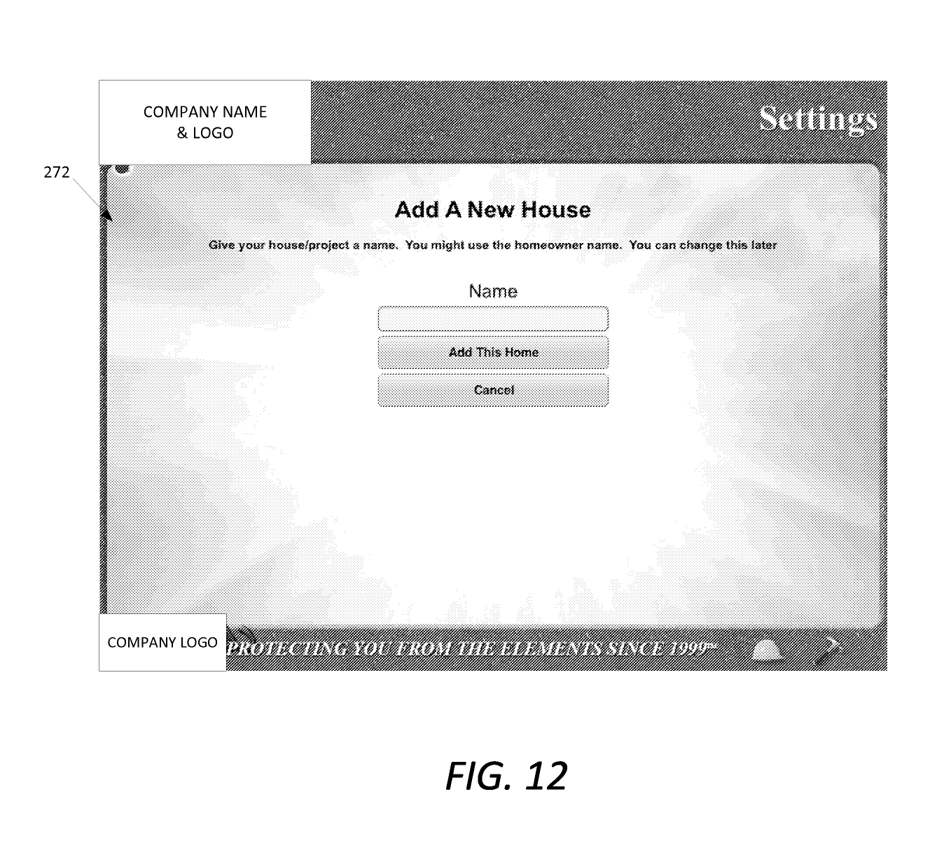

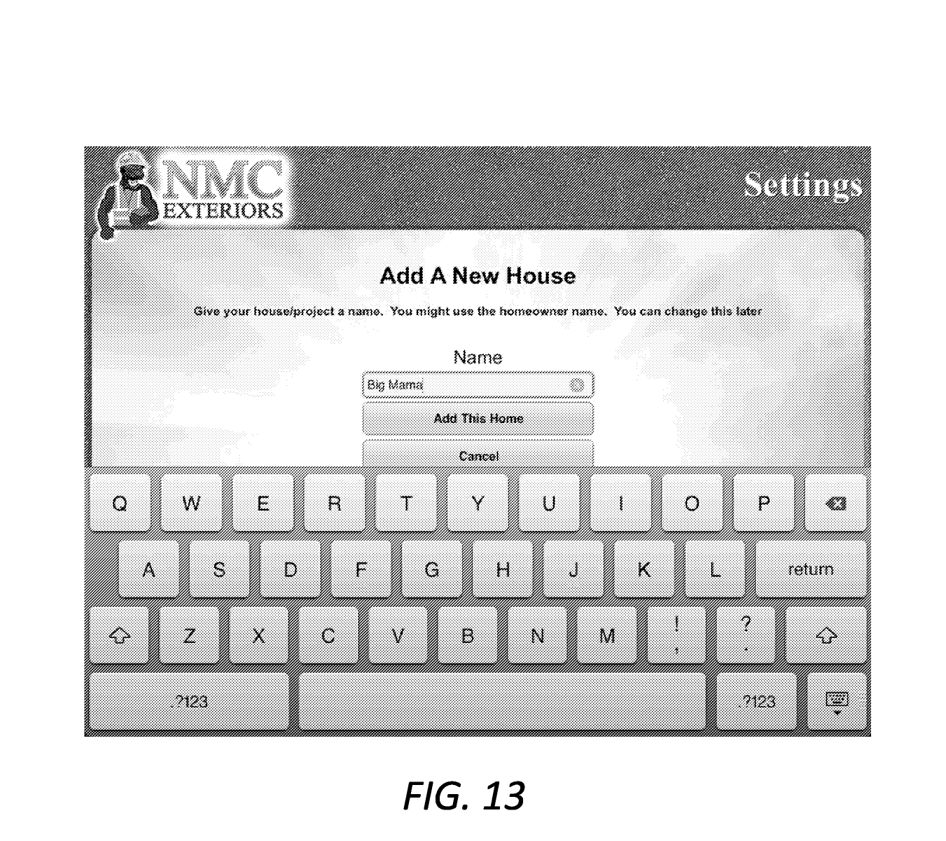

In some embodiments, the new customer addition control 260 is arranged within the customer management region 220. When the salesperson selects the new customer addition control 260, the customer management engine 234 generates and display a customer addition screen 272 (FIGS. 12 and 13) that permits the salesperson to add the information about the new customer and building.

FIG. 11 illustrates an example subject building edit screen 264. In some embodiments, the subject building edit screen 264 provides text boxes 268 that allow the salesperson to input information on the subject building 92. Such building information includes, for example, the target customer's information (e.g., name, contact information, and additional note) and the building information (e.g., address). Once the update is done and the salesperson selects to save the update, the customer management engine 234 stores the updated building information in the mobile computing device 102 and returns to the main control screen 200.

In some embodiments, the subject building edit screen 264 includes a rating control 270. Before and/or after the customized sales presentation 106 is given to the target customer, the salesperson can rate the sales potential with respect to the target customer. The rating control 270 is configured to permit the salesperson to input a level of sales potential through the rating control 270. In this example, the salesperson rates the sales potential by the number of stars (between one start to five stars). Once the update is done, the main control screen 200 displays ratings 271 for each customer within the customer management region 220.

FIG. 12 illustrates an example customer addition screen 272. In some embodiments, the customer addition screen 272 provides one or more text boxes that allow the salesperson to input information on the new customer. In some embodiments, the customer addition screen 272 requires the name of the new customer, as shown in FIG. 12.

FIG. 13 illustrates the customer addition screen 272 of FIG. 12 with a virtual keyboard displayed on the touch-sensitive display device 156 to permit the salesperson to input the information on the new customer. As shown, the salesperson can type the name of the new customer into the text box with the virtual keyboard displayed on the touch-sensitive display device. In other embodiments, as described above, the input device can be a keyboard externally connected to the mobile computing device 102 and/or a microphone incorporated in or externally connected to the mobile computing device 102. Once the information on the new customer is received and the salesperson selects to save the information, the customer management engine 234 stores the received information in the mobile computing device 102 and returns to the main control screen 200.

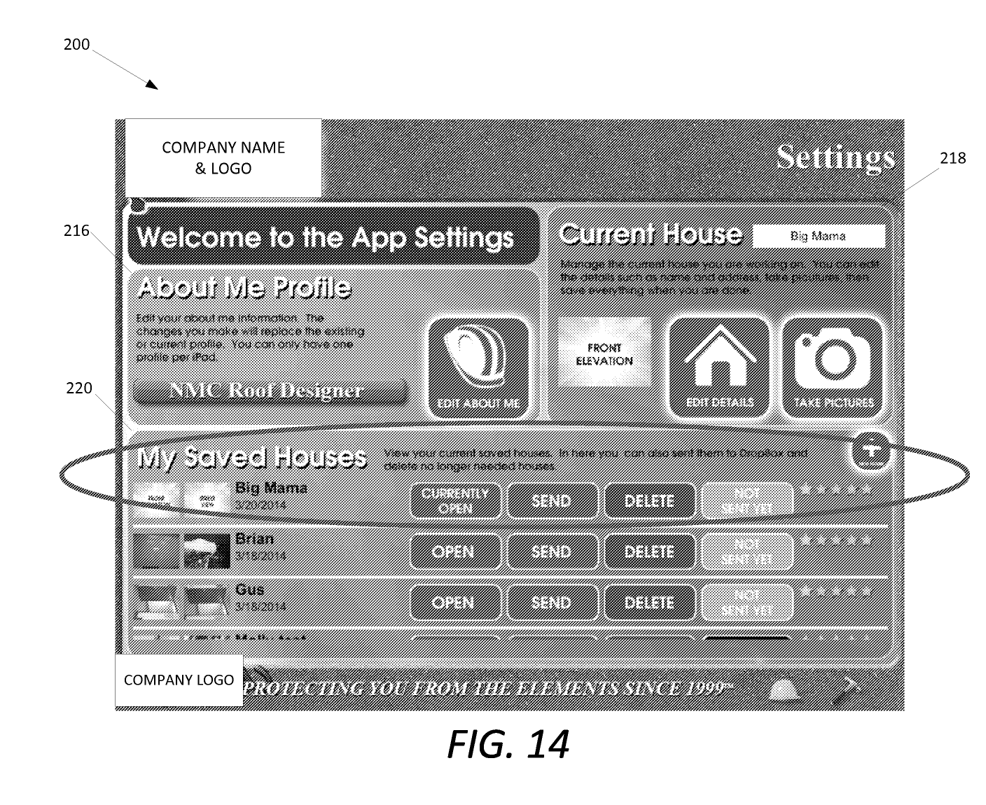

FIG. 14 illustrates an example main control screen 200 that shows the new customer added in the customer addition screen 272. In some embodiments, the newly added customer is listed with the existing customers in the customer management region 220.

FIG. 15 is a flowchart illustrating an example method 280 of operating the photograph capture engine 236. In this embodiment, the method 280 includes operations 282 and 284. In some embodiments, the method 280 includes operations that are performed by a processor (such as the processing device 120, shown in FIG. 3). As used herein, methods include actions or operations that are performed by a user or executed by a computer, or combinations of these.

At the operation 282, the photograph capture engine 236 prompts the salesperson to take one or more photographs of the subject building 92 at the customer site 90. For example, when the salesperson wants to take photographs of the subject building 92 at the customer site 90 and instruct the photograph capture engine 236 as such, the photograph capture engine 236 initiates the camera module 152 of the mobile computing device 102, and the salesperson takes photographs with the camera module 152.

At the operation 284, the photograph capture engine 236 captures the photographs of the subject building 92 taken by the salesperson. As discussed below, the captured photographs are employed to generate the customized sales presentation 106.

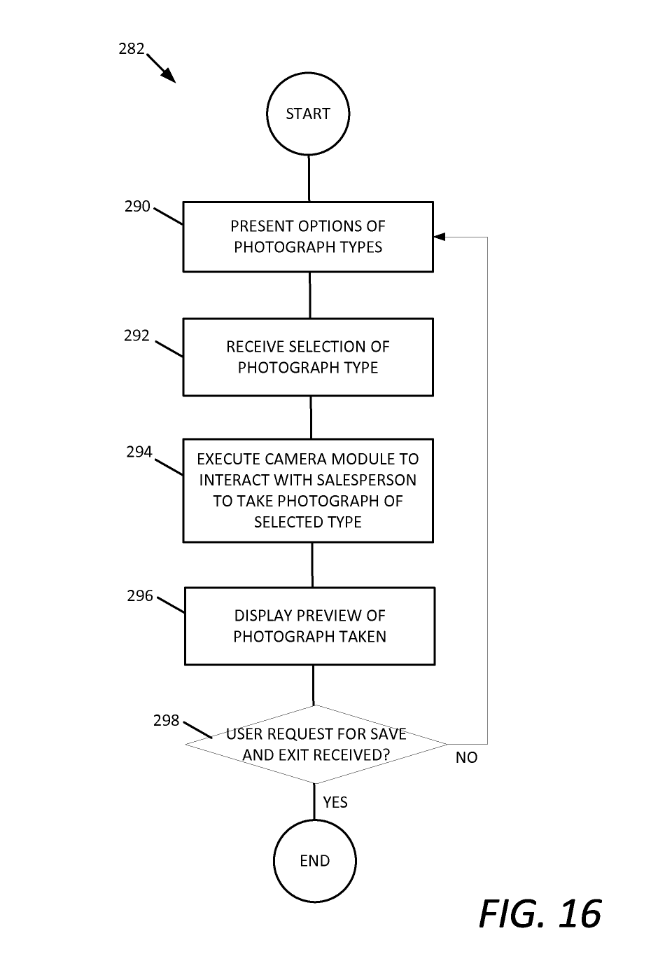

FIG. 16 is a flowchart illustrating an example method of prompting the salesperson to take photographs of the subject building 92 at the customer site 90. In some embodiments, the method performs the operation 282 of FIG. 15. In this embodiment, the method includes operations 290, 292, 294, 296 and 298. In some embodiments, the method 280 includes operations that are performed by a processor (such as the processing device 120, shown in FIG. 3). As used herein, methods include actions or operations that are performed by a user or executed by a computer, or combinations of these.

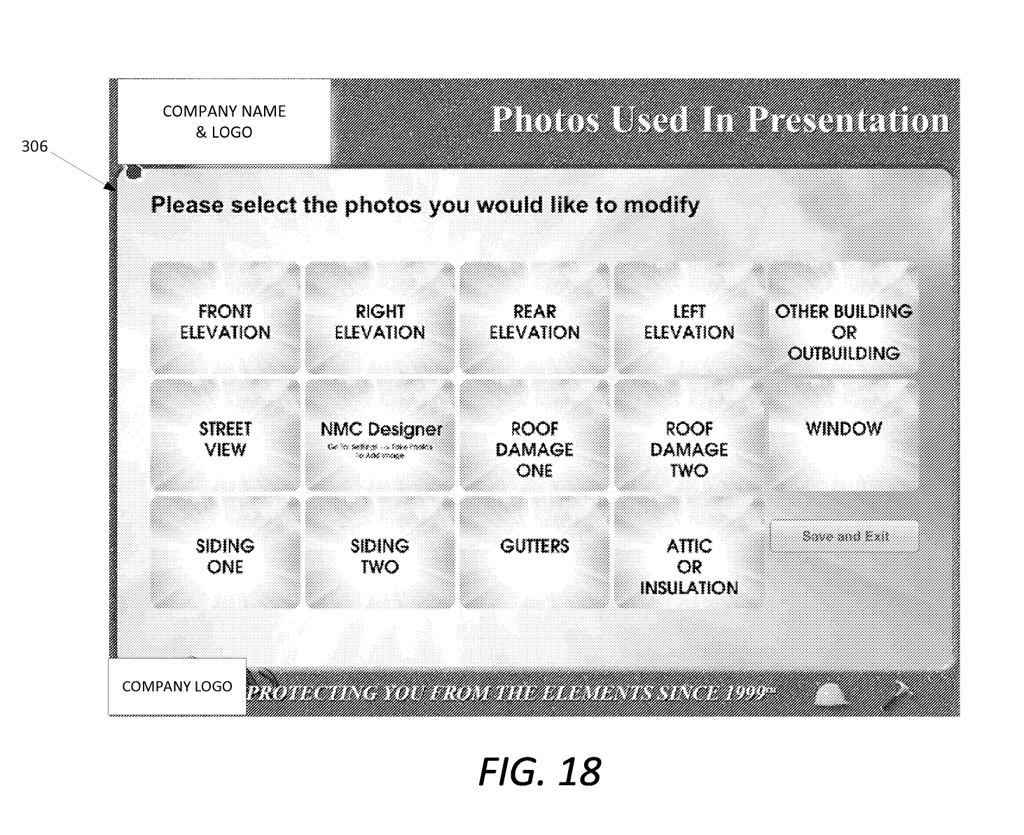

At the operations 290, the photograph capture engine 236 presents options of predetermined photograph types on the display screen of the mobile computing device 102. The options of the photograph types include, for example, a front elevation view, a right elevation view, a rear elevation view, a left elevation view, a street view, a roof, windows, side views, gutters, and an attic. In other embodiments, the options of the photograph types include other views or portions of the subject building 92. In some embodiments, the photograph capture engine 236 generates and displays blank frames or boxes that represent different types of photograph, as shown in FIG. 18. The blank frames or boxes can contain labels therein or around them to assist the salesperson in identifying what types of photograph can be captured for customizing the sales presentation 106.

At the operation 292, the photograph capture engine 236 receives a user selection of a photograph type through the input device. In this example, the salesperson can select a desired photograph type by touching the corresponding frame or box displayed on the touch-sensitive display device 156. For example, the salesperson can touch a frame labeled as a front elevation view to take a photograph of the front elevation view of the subject building 92. In other embodiments, the photograph capture engine 236 provides different input mechanisms to receive a user selection of a photograph type, such as selectable controls on the touch-sensitive display screen or physical buttons incorporated into or external from the mobile computing device 102.

At the operation 294, the photograph capture engine 236 executes the camera module 152 to interact with the salesperson to take one or more photographs for the photograph type selected at the operation 292. In some embodiments, the photograph capture engine 236 initiates a camera mode of the mobile computing device 102 so that the salesperson takes a photograph by the camera module 152.

At the operation 296, the photograph capture engine 236 displays a preview of the photograph taken by the salesperson at the operation 294. In some embodiments, the photograph taken is displayed with a label that indicates the photograph type of the photograph taken. In other embodiments, the photograph taken is displayed within a frame or box associated with the photograph type selected at the operation 292.

At the operation 298, the photograph capture engine 236 determines whether the salesperson requests for saving and exiting the photograph capture engine 236. If the salesperson selects to save and exit the photograph-taking mode (“YES” at the operation 298), the photograph capture engine 236 ceases to operate. If the salesperson does not input selection of quitting the photograph capture engine 236 and wants to continue to take photographs of different types (“NO” at the operation 298), the method returns to the operation 290.

FIG. 17 illustrates an example user interface 302 for the salesperson to execute the photograph capture engine 236. In some embodiments, the user interface 302 includes a take-photos control 304 arranged within the subject building management region 218. When the salesperson selects the take-photos control 304, the photograph capture engine 236 generates and displays a photograph-taking screen 306 (FIG. 18) that permits the salesperson to take one or more photographs of the subject building 92 and the surroundings at the customer site 90.

FIG. 18 illustrates an example photograph-taking screen 306. The photograph-taking screen 306 displays photograph types that can be used in the customized sales presentation 106. The photograph-taking screen 306 also operates to receive a user selection of a desired photograph type, thereby causing the photograph capture engine 236 to initiate the camera module 152 with which the salesperson can interact to take a photograph of the selected type. In the depicted example, the photograph-taking screen 306 displays a plurality of frames or boxes to indicate photograph types used in the customized sales presentation 106. As shown, the frames are labeled with photograph types. Examples of the photograph types include a front elevation view, a right elevation view, a rear elevation view, a left elevation view, a street view, a roof, damaged portions of the roof, windows, views of sidings, gutters, and an attic or insulation. In some embodiments, the salesperson can select one of the frames to initiate the camera module 152 and take a photograph for the selected frame with the camera module 152.

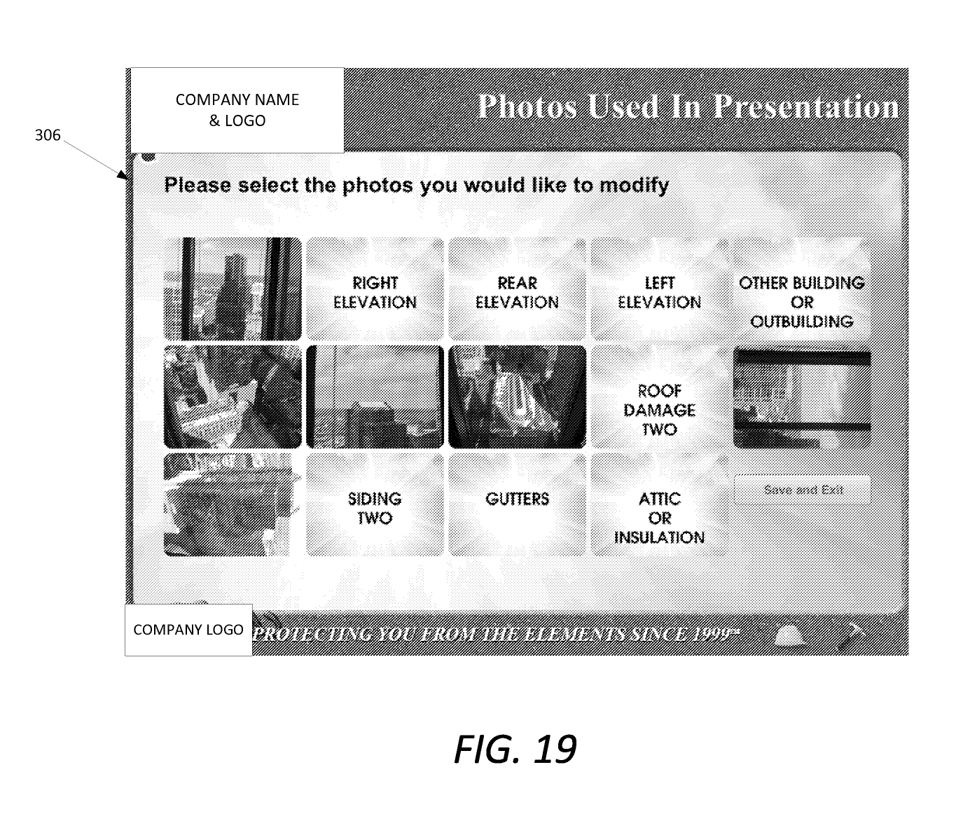

FIG. 19 illustrates the photograph-taking screen 306 of FIG. 18 with photographs of different types taken with the camera module 152. In the depicted example, the salesperson selected and took photographs of a front elevation view, a street, a roof, a damaged portion of the roof, windows, and a first siding view, and thus the corresponding frames displays the photographs taken for the selected photograph types.

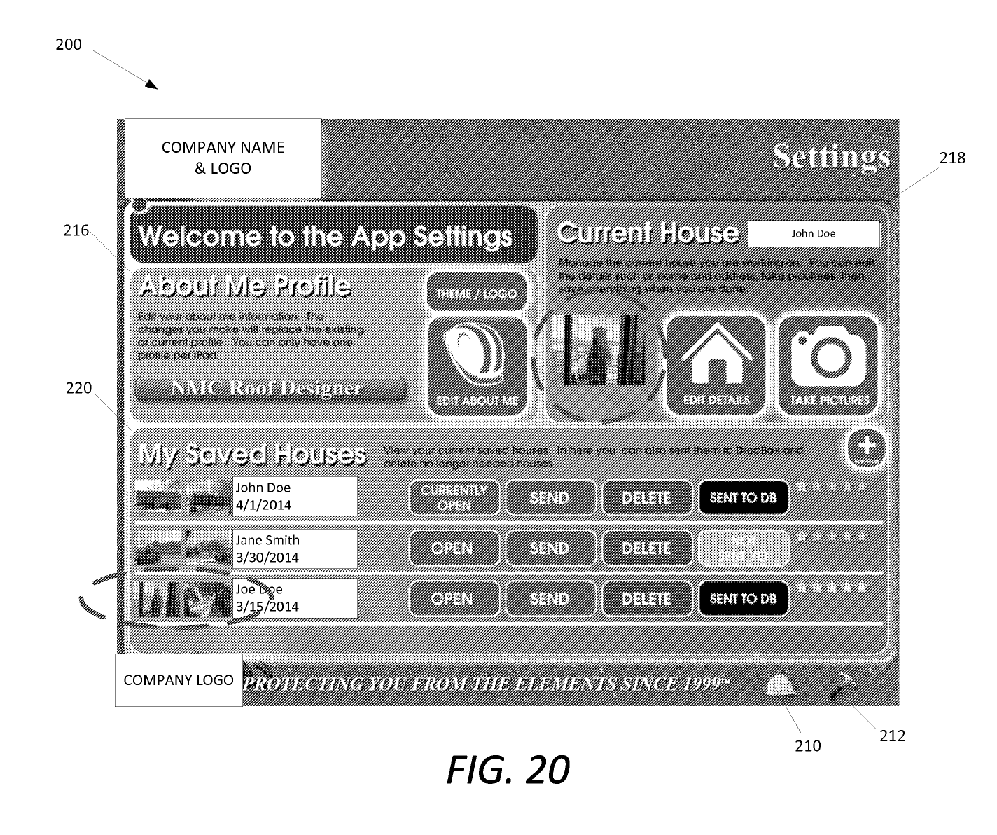

FIG. 20 illustrates the main control screen 200 that has been updated with at least some of the photographs taken by the salesperson at the photograph-taking screen 306, as described in FIGS. 18 and 19.

FIG. 21 illustrates an example presentation engine 174. In some embodiments, the presentation engine 174 includes a design demonstration engine 314.

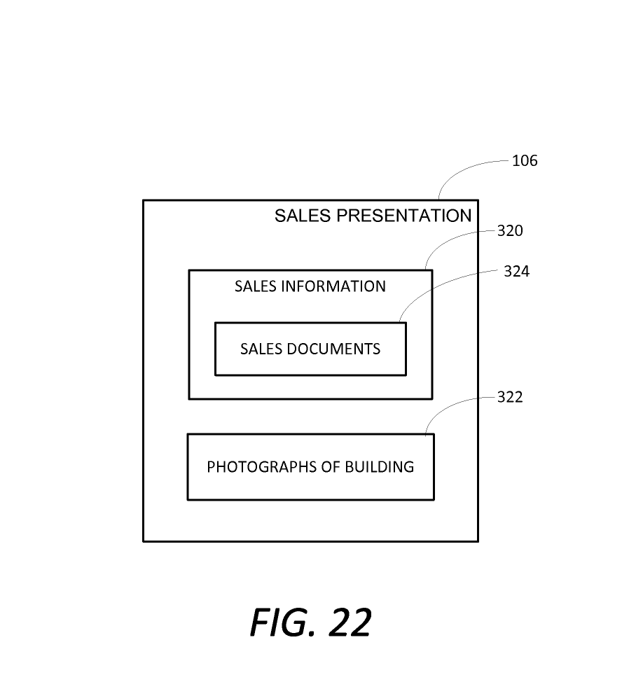

The presentation engine 174 operates to generate and present the customized sales presentation 106 on the mobile computing device 102. In particular, the presentation engine 174 generates the customized sales presentation 106 to assist the salesperson in making the customized sales presentation 106 to the target customer, and then present the sales presentation to the target customer through the mobile computing device 102. Examples of the presentation engine 174 is illustrated and described in more detail with reference to FIGS. 22-34.

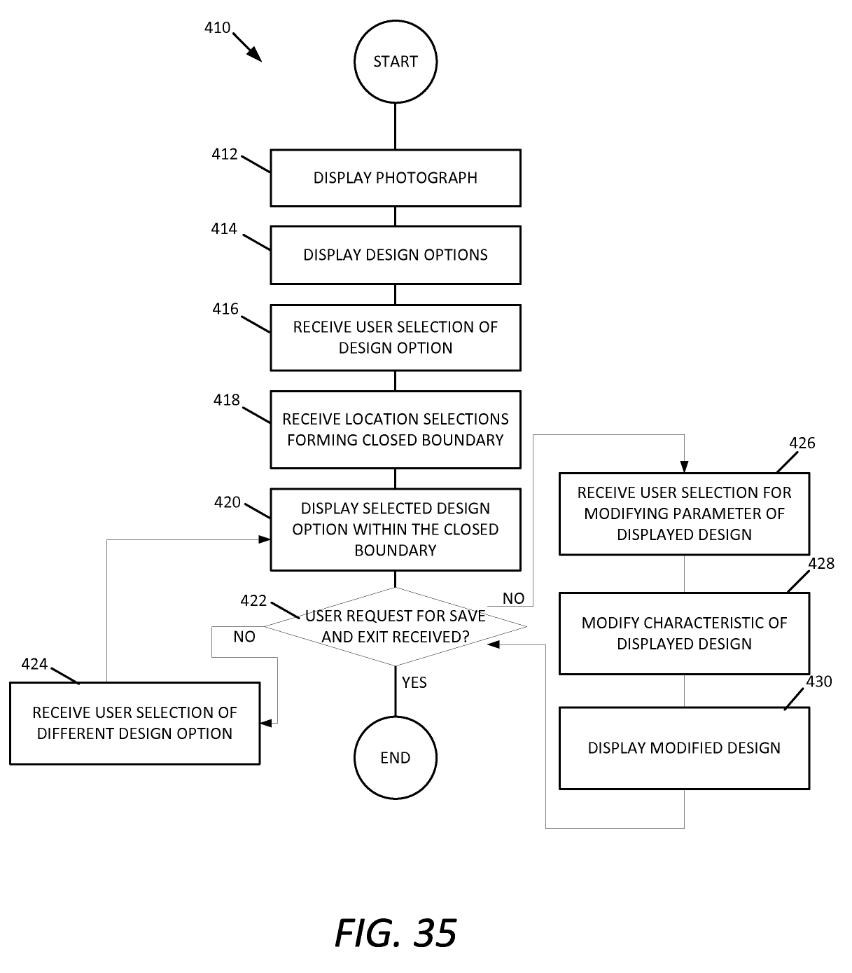

The design demonstration engine 314 operates to demonstrate different options of building materials applied to the subject building 92. Examples of the design demonstration engine 314 is illustrated and described with reference to FIGS. 35-51.

In some embodiments, the salesperson can start the customized sales presentation 106 by selecting a predetermined selectable control displayed on the main control screen 200. In some embodiments, such a predetermined selectable control is the company identifier 206 (FIG. 5). Because the company identifier 206 remains always displayed while the on-site sales presentation engine 104 is in use, the salesperson can easily access the sales presentation 106.

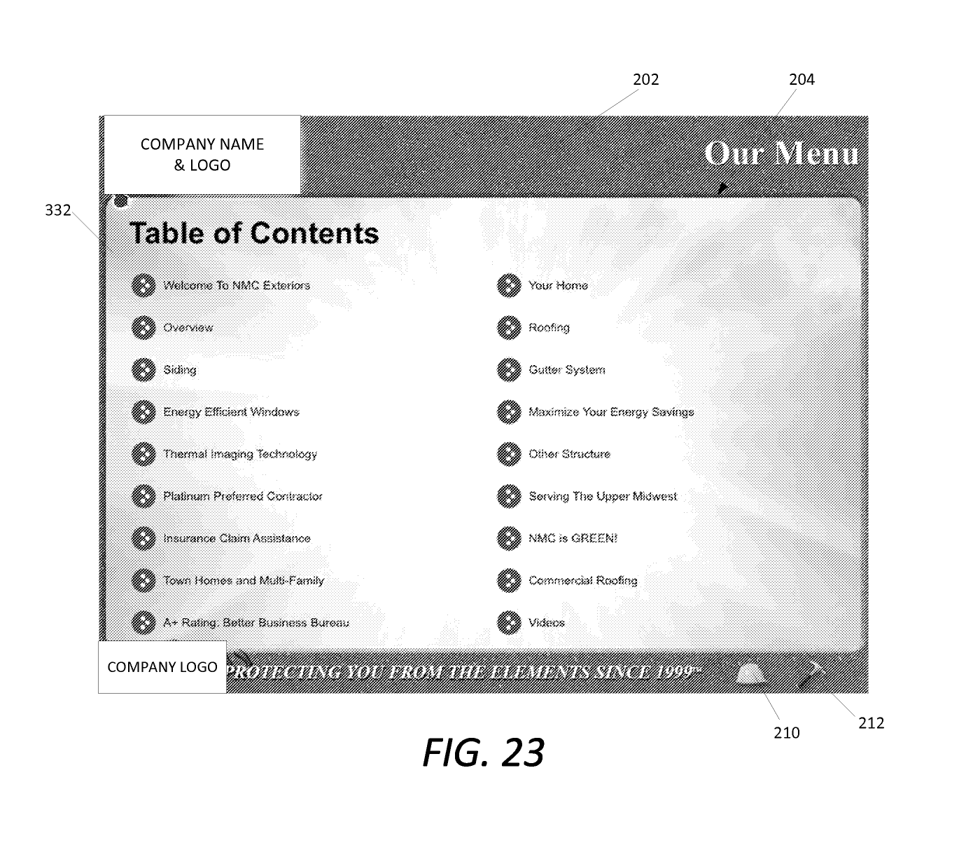

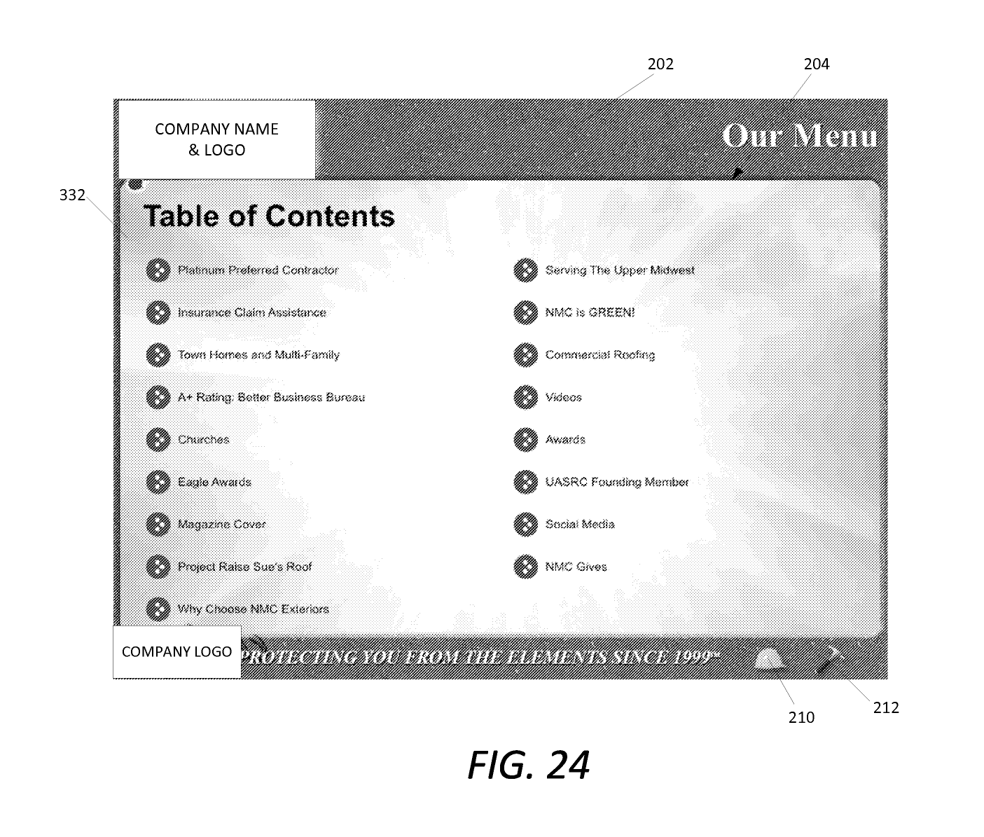

In some embodiments, the presentation engine 174 presents a table of contents screen 332 (FIGS. 23 and 24) when the salesperson first starts giving the sales presentation 106. In other embodiments, the presentation engine 174 stores a screen of the sales presentation 106 that the salesperson left off and resumes the screen when the salesperson later select the company identifier 206.

FIG. 22 illustrates an example customized sales presentation 106. The customized sales presentation 106 includes a variety of information that helps the salesperson promote construction business with the target customer. In some embodiments, the customized sales presentation includes sales information 320 and at least some of the photographs 322 of the subject building 92 captured by the photograph capture engine 236. In some embodiments, the sales information 320 includes sales documents 324.

The sales information 320 includes, for example, an introduction of the construction contractor company, a presentation of the subject building 92 with the subject building photographs 322, a presentation of different options of building materials or construction materials, a presentation of product knowledge, a presentation of product specifications and a presentation public relations information. The sales information 320 can include any information that promotes the sales business to target customers.

The subject building photographs 322, which have been captured by the photograph capture engine 236, are assigned to predetermined portions of the sales presentation 106. In some embodiments, one or more of the subject building photographs 322 are embedded as part of the sales information 320 in the sales presentation 106. In other embodiments, one or more of the subject building photographs 322 are displayed as single pages in the sales presentation 106.

The sales documents 324 include, for example, warrant documents and contract documents. In some embodiments, the customized sales presentation 106 operates to receive the target customer's input, such as signatures, on the sales documents 324.

As discussed below in more detail, the sales information 320 and the photographs 322 of the subject building 92 are customized and assigned to the sales presentation 106 based upon different needs of target customers. Examples of the customized sales presentation 106 with the sales information 320 and the subject building photographs 322 are illustrated and described with reference to FIGS. 23-34.

FIGS. 23 and 24 illustrate an example table of contents screen 332 of the sales presentation 106. The table of contents screen 332 is displayed within the information display frame 204 and shows the information that is presented in the sales presentation 106.

In some embodiments, the items listed in the table of contents screen 332 operate as shortcuts to associated screens. For example, the salesperson can select one of the items to directly navigate the associated screen for the relevant sales information. In this configuration, the sales presentation 106 need not be started from the beginning, and gives the salesperson a choice where to start the sales presentation 106.

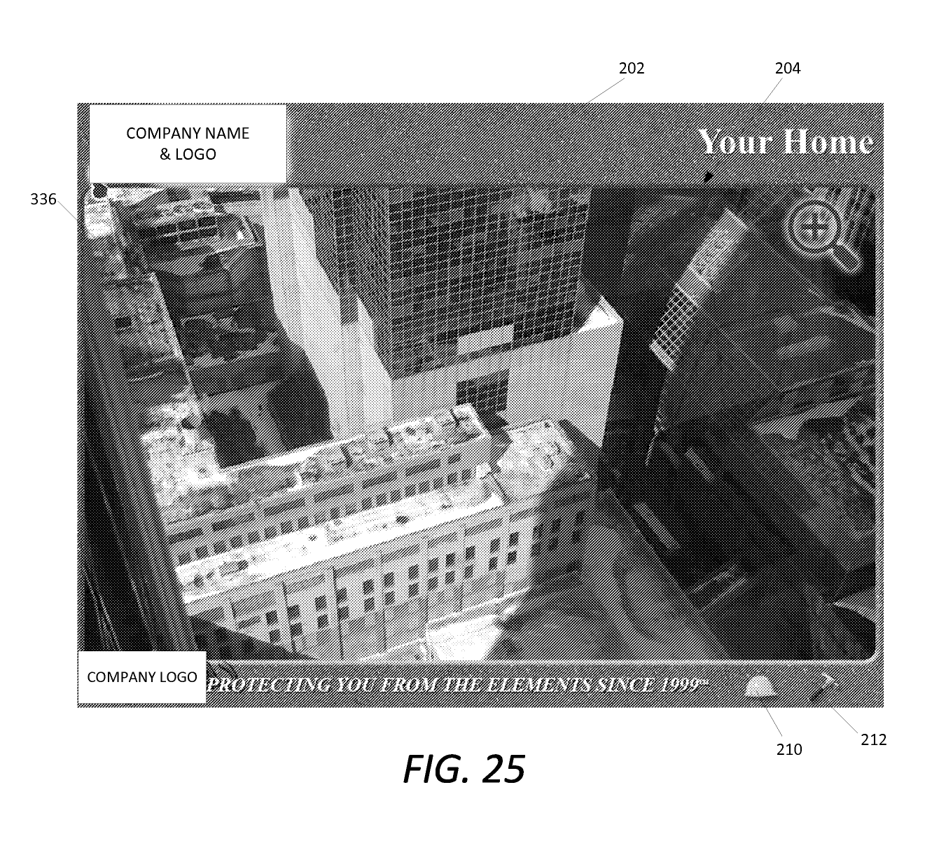

FIG. 25 illustrates an example subject building presentation screen 336. In some embodiments, the subject building presentation screen 336 displays one of the subject building photographs 322 in the information display frame 204.

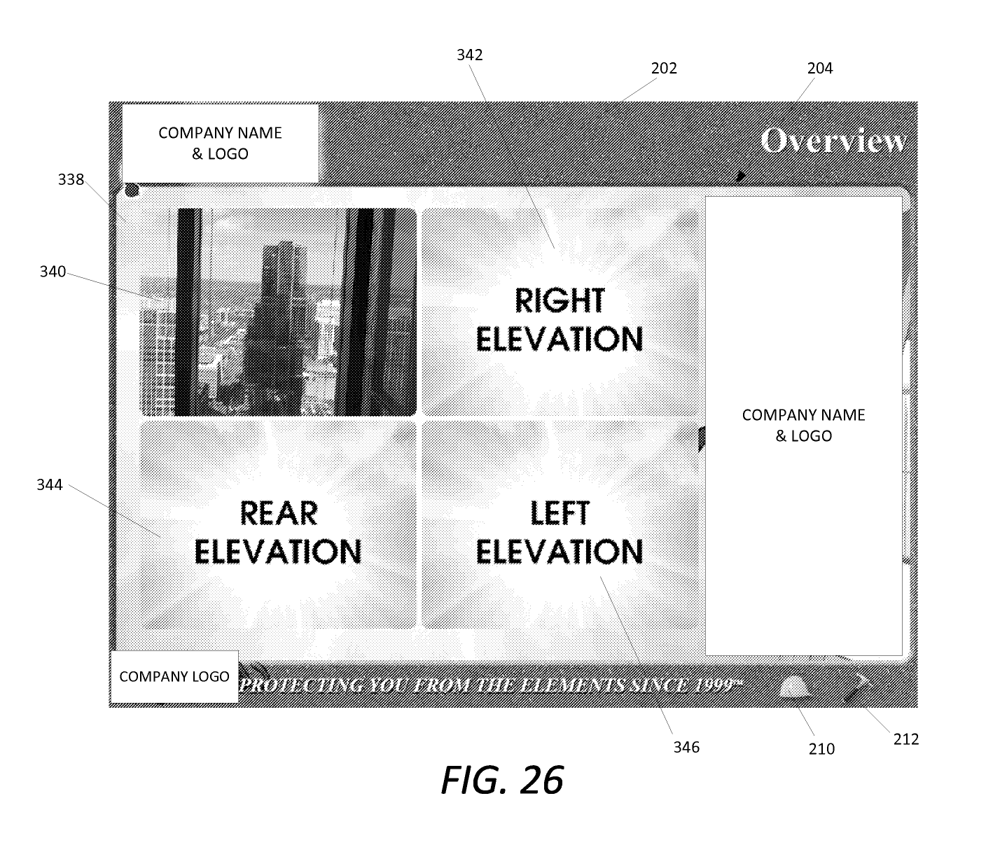

FIG. 26 illustrates an example overview screen 338. The overview screen 338 operates to display the subject building 92 in one or more points of view. In some embodiments, the overview screen 338 displays one or more of the subject building photographs 322 in the information display frame 204.

The overview screen 338 is configured to present one or more of the subject building photographs 322 of predetermined types. For example, the overview screen 338 is configured to include front, right, rear, and left elevation views 340, 342, 344 and 346 of the subject building 92. The presentation engine 174 operates to read the subject building photographs 322 of the corresponding types, and assign and display them in the proper portions of the overview screen 338.

In some embodiments, when a photograph of a particular type is not taken by the salesperson during the operation of the photograph capture engine 236, the presentation engine 174 disables a predetermined portion of the customized sales presentation that is allotted for the particular photograph type. In some embodiments, the presentation engine 174 displays a blank frame at the predetermined portion of the sales presentation. In some embodiments, the blank frame is labeled with the particular photograph type for which a photograph has not been captured. In other embodiments, the presentation engine 174 assign and display a stock photograph, which is stored in the mobile computing device 102, replacing the blank frame. In yet other embodiments, the presentation engine 174 assign and display a predetermined picture or symbol, such as the company logo, replacing the blank frame. These features are applicable to other screens in the customized sales presentation in the similar manner.

As shown in FIG. 26, the overview screen 338 displays the subject building photograph 322 of the front elevation type that has been captured during the operation of the photograph capture engine 236, and displays the blank frames for the right, rear, and left elevation photograph types 342, 344 and 346.

In some embodiments, when the salesperson selects the displayed photograph of the subject building, the presentation engine 174 enlarges the selected photograph and displays it either in the information display frame 204 or in the entire screen of the display.

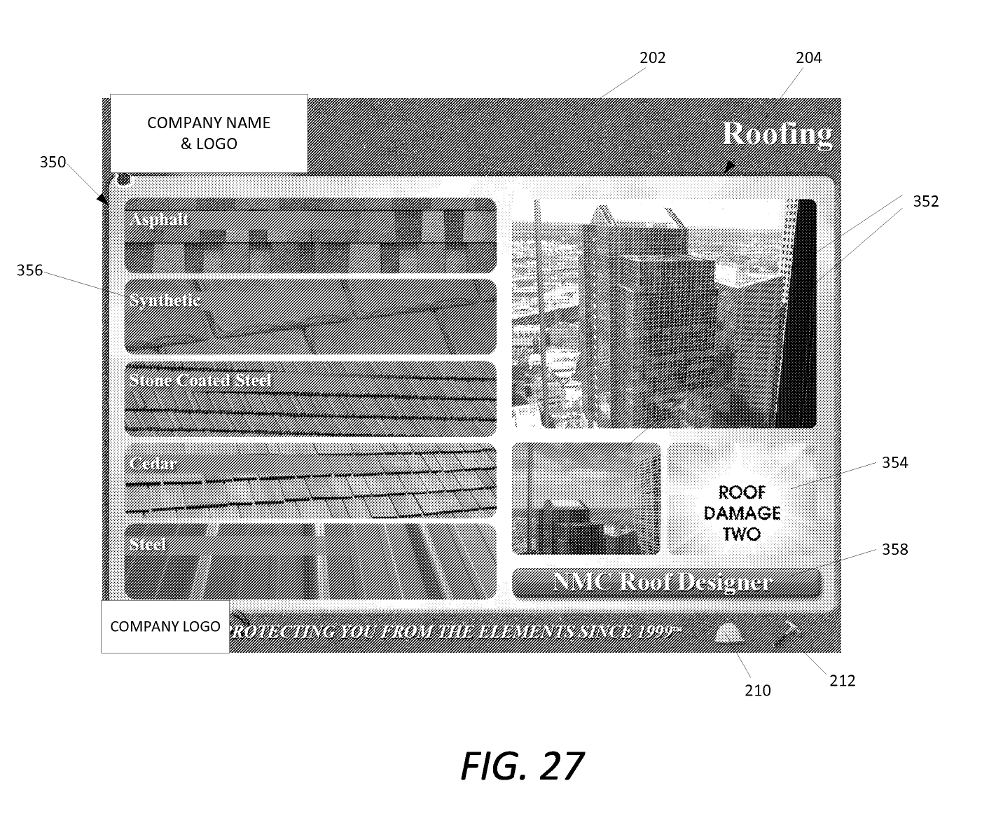

FIG. 27 illustrates an example roofing screen 350. The roofing screen 350 operates to give a presentation on the roofing of the subject building 92. The roofing screen 350 includes one or more 352 of the subject building photographs 322 that are captured for roof photograph types or damages to the roof of the subject building 92. The roofing screen 350 can also include one or more blank frames 354 when the types of photographs associated with the frames have not been captured by the operation of the photograph capture engine 236. The operation of the presentation engine 174 for assigning and displaying photographs to predetermined portions of the sales presentation 106 in the screen is the same as described with reference to FIG. 26, and thus the description thereof is omitted for brevity purposes.

In some embodiments, the roofing screen 350 further includes options of building materials 356 available for roofing work for the subject building 92. In some embodiments, when the salesperson selects the options of the building materials 356, the presentation engine 174 presents the details of the selected building material option in the information display frame 204.

In some embodiments, the roofing screen 350 includes a roof design demonstration control 358 configured to execute the design demonstration engine 314. Examples of design demonstration engine 314 are illustrated and described with reference to FIGS. 35-51.

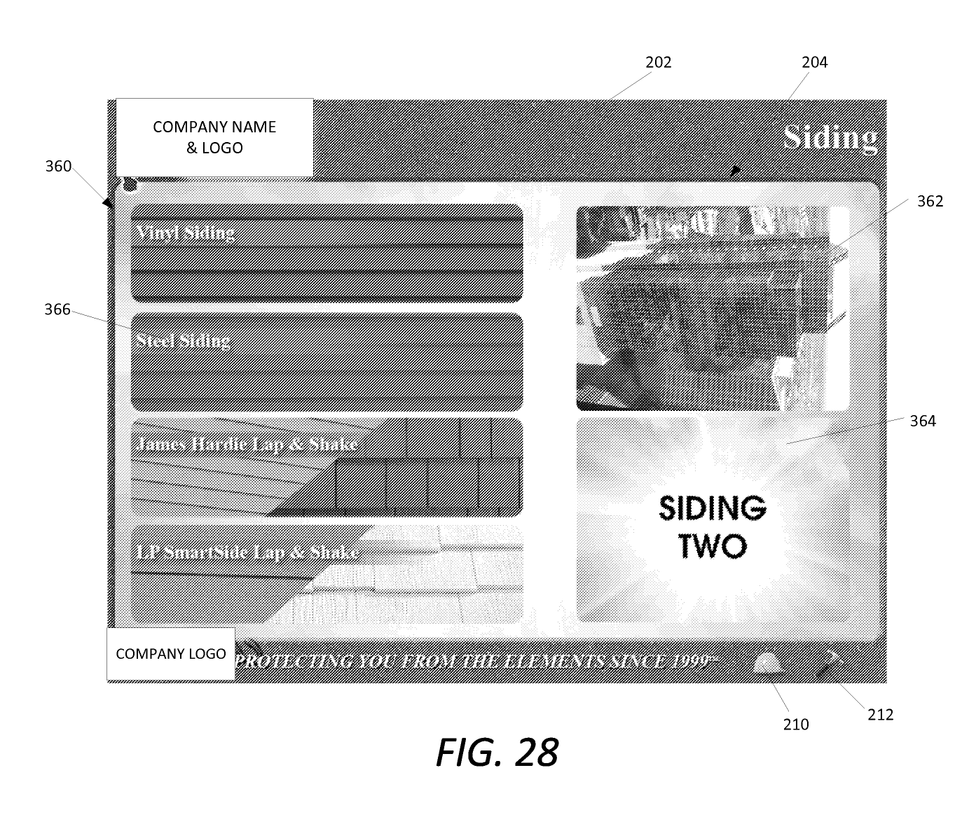

FIG. 28 illustrates an example siding screen 360. The siding screen 360 operates to give a presentation on the siding work of the subject building 92. The configuration and operation of the siding screen 360 is similar to the roofing screen 350, and thus the description thereof is omitted for brevity purposes.

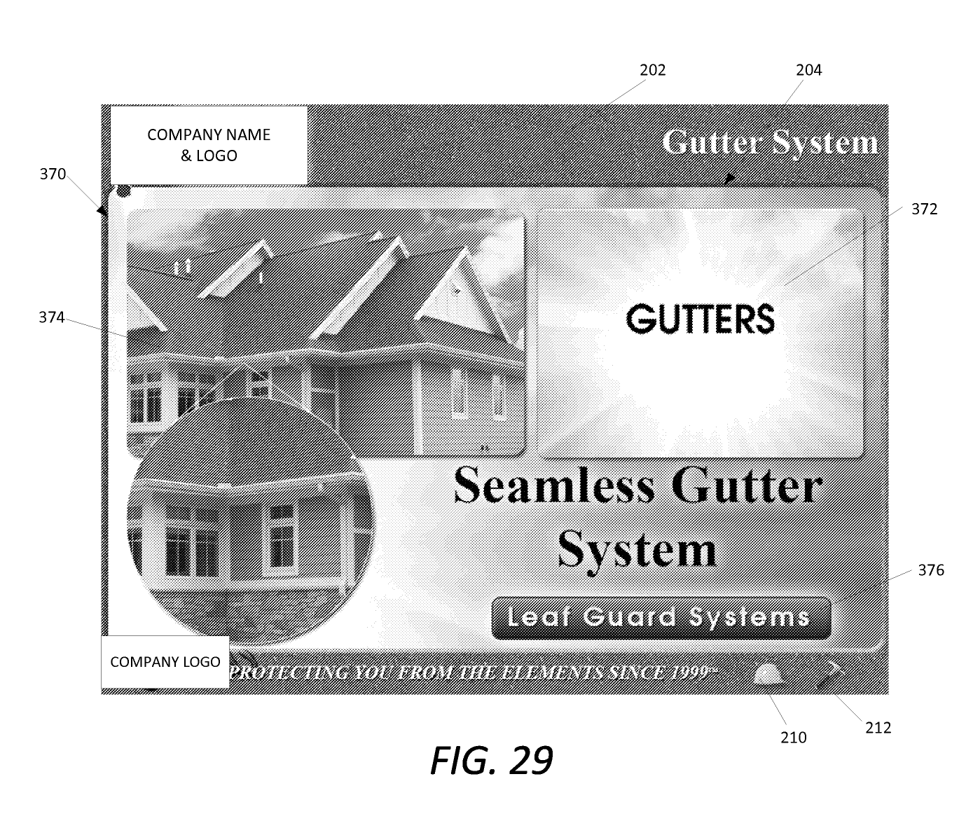

FIG. 29 illustrates an example gutter system screen 370. The gutter system screen 370 operates to give a presentation on the gutter work of the subject building 92. The configuration and operation of the gutter system screen 370 is similar to the roofing screen 350, and thus the description thereof is omitted for brevity purposes.

In some embodiments, the gutter system screen 370 includes a selectable control 376 for additional information. The presentation engine 174 operates to read and display an additional piece of sales information in the information display frame 204 when the salesperson selects the control 376. The additional information includes, for example, construction or building materials for different purposes.

In some embodiments, the control 376 for additional information is animated when the control 375 shows up. For example, the control 376 is configured to fly in from the side to a predetermined position in the screen as the screen is displayed on the mobile computing device 102. In other embodiments, the control 376 is animated with different effects, such as gradual appearing, fading, floating in, zooming, swiveling, and bouncing. Such configurations of the control 376 are applicable to other selectable controls contained in other screens of the sales presentation 106.

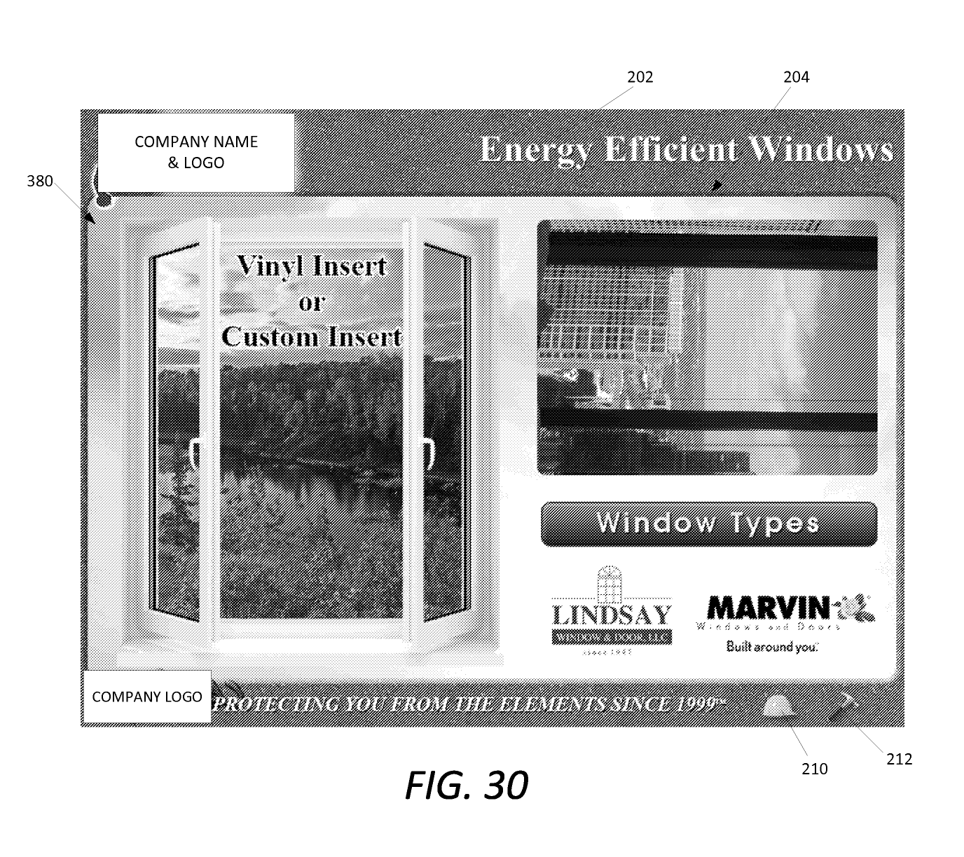

FIG. 30 illustrates an example windows screen 380. The windows screen 380 operates to give a presentation about the windows work of the subject building 92. The configuration and operation of the windows screen 380 is similar to the roofing screen 350, and thus the description thereof is omitted for brevity purposes.

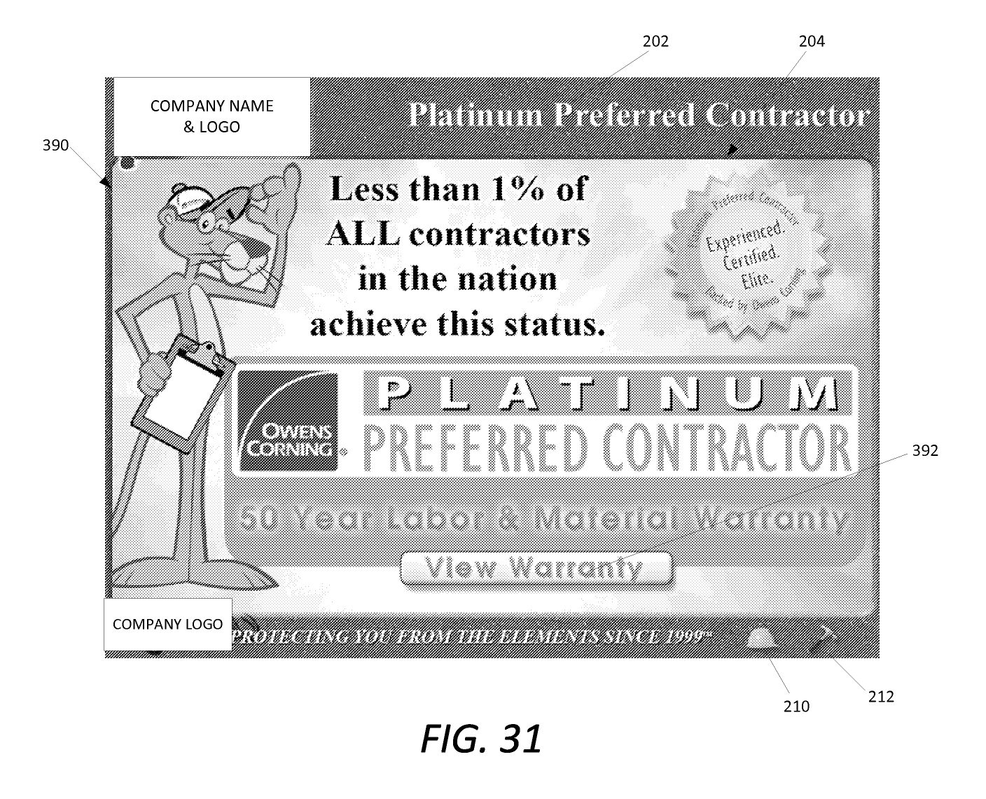

FIG. 31 illustrates an example warranty screen 390. The warranty screen 390 operates to give a presentation about the warranty from the construction contractor company. In some embodiments, the warranty information is displayed in the warranty screen 390. In other embodiments, the warranty screen 390 includes a selectable control 392 that executes the presentation engine 174 to display the warranty information in the screen when the salesperson selects the control 392.

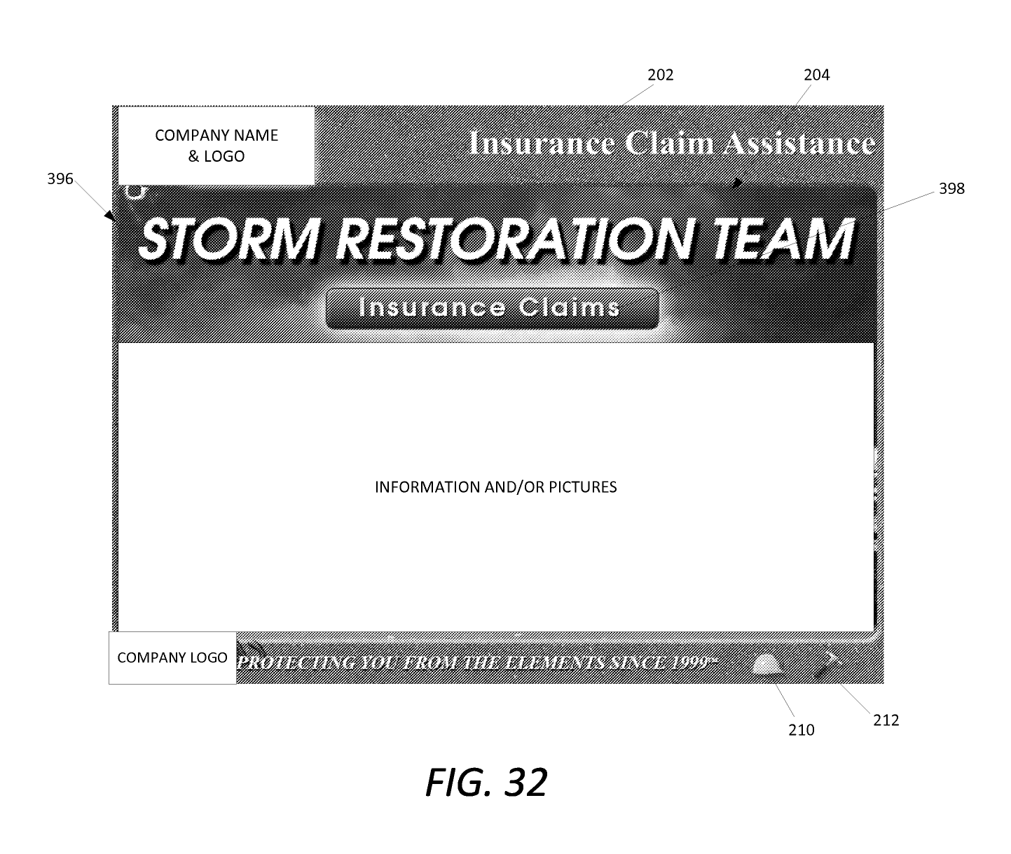

FIG. 32 illustrates an example insurance claim work screen 396 that is configured to give a presentation of the information on insurance claim work from the construction contractor company. In some embodiments, the insurance claim work information is displayed in the screen 396. In other embodiments, the insurance claim work screen 396 includes a selectable control 398 that executes the presentation engine 174 to display the insurance claim work information in the screen when the salesperson selects the control 398.

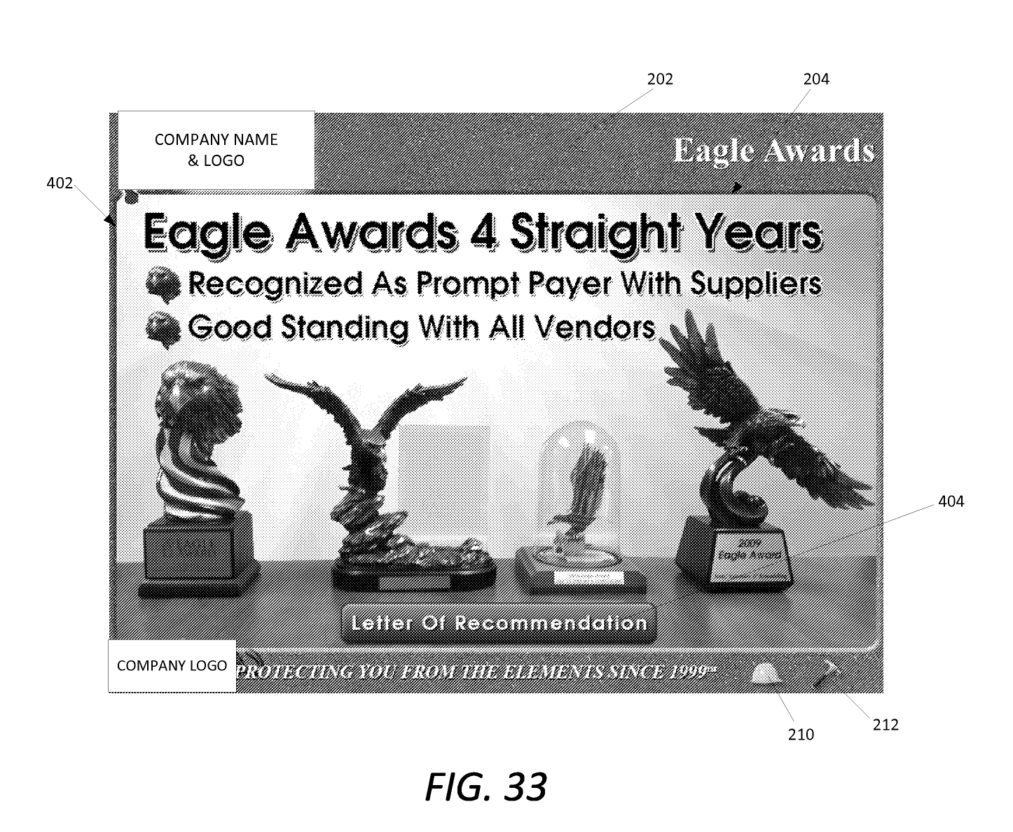

FIG. 33 illustrates another example promotion screen 402. In some embodiments, the promotion screen 402 describes awards or prizes won by the construction contractor company. In other embodiments, the promotion screen 402 includes a selectable control 404 that executes the presentation engine 174 to display letters of recommendation or existing customers' review.

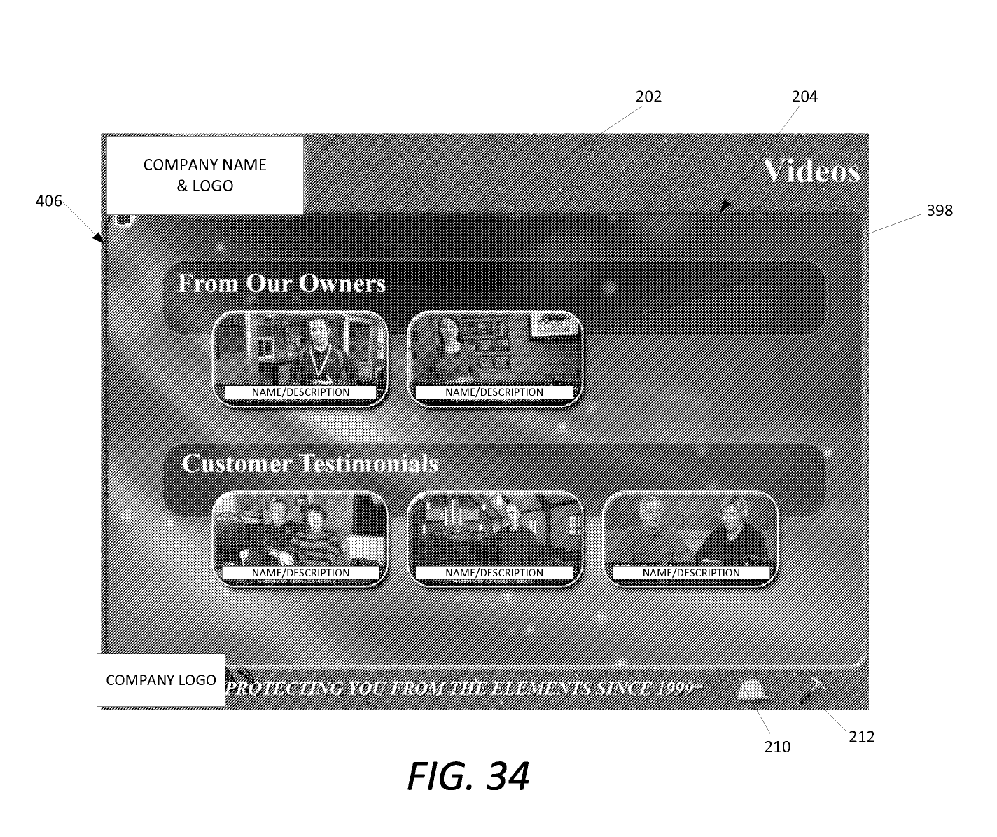

FIG. 34 illustrates yet another promotion screen 406 that includes video clips for promotional purposes. The video clips include, for example, videos about the construction contractor company's introduction, videos of the previous customer's testimonials, how-to videos, tutorial videos, videos about building materials, time-lapse videos of construction work, and any other videos that can promote the business with the customers.

In some embodiments, the different screens about several items, such as displayed in the table of contents screen 332 (FIGS. 23 and 24), are navigated through the input device of the mobile computing device 102. Where the input device is a touch-sensitive display device, the screens can be navigated or switched by the salesperson's touch interaction with the touch-sensitive display device. For example, the salesperson can switch between the screens by sliding his or her finger or a touch-sensitive tool on the touch-sensitive display device in a predetermined manner, such as left-to-right action or vice versa.

In addition to the screens described above, the customized sales presentation 106 can further include a variety of screens with different sales information and at least some subject building photographs captured during the operation of the photograph capture engine 236. In some embodiments, according to the salesperson's selection or the target customer's needs, the screens with sales information can be selected and organized in different ways.

FIG. 35 a flowchart illustrating a method 410 of operating the design demonstration engine 314. In this embodiment, the method 410 includes operations 412, 414, 416, 418, 420, 422, 424, 426, 428 and 430. In some embodiments, the method 410 includes operations that are performed by a processor (such as the processing device 120, shown in FIG. 3). As used herein, methods include actions or operations that are performed by a user or executed by a computer, or combinations of these.

At the operation 412, the design demonstration engine 314 operates to display the subject building photograph of a predetermined type.

At the operation 414, the design demonstration engine 314 operates to display different design options of building materials that are applicable to the subject building 92. In some embodiments, the design demonstration engine 314 displays the design options of building materials when the design demonstration engine 314 receives a request for displaying the design options by the salesperson through the input device of the mobile computing device 102. The design options include, for example, different brands, styles, colors, patterns, materials, sizes of building materials.

At the operation 416, the design demonstration engine 314 receives a user selection of one of the displayed design options through the input device of the mobile computing device 102.

At the operation 418, the design demonstration engine 314 receives a plurality of location selections by the salesperson who interacts with the input device. The plurality of location selections represents a plurality of locations on the displayed photograph. The plurality of locations selected forms a closed boundary.

At the operation 420, the design demonstration engine 314 displays the selected design option within the boundary defined by the plurality of locations on the displayed photograph. The selected design option overlays the displayed photograph within the boundary.

At the operation 422, the design demonstration engine 314 determines whether the salesperson requests to save the photograph with the selected design option and exit the operation of the design demonstration engine 314. In some embodiments, the design demonstration engine 314 displays one or more selectable control that the salesperson can select to input the request for saving and exiting the operation of the design demonstration engine 314. If the salesperson chooses to save and exit (“YES” at the operation 422), the design demonstration engine 314 stores the subject building photograph with the selected design of building material overlaying thereon, and exits the operation thereof. In some embodiments, the sales presentation 106 returns to the main control screen 200. In other embodiments, the sales presentation 106 returns to the last screen before the design demonstration engine 314 starts its operation.

If the design demonstration engine 314 determines that there is no request for save and exit from the salesperson (“NO” at the operation 422), the method 410 proceeds to either the operation 424 or the operation 426.

At the operation 424, the design demonstration engine 314 receives a user selection of a different design among the displayed design options through the input device. Then, the design demonstration engine 314 returns to the operation 420 and displays the different design within the boundary on the displayed photograph, replacing the first selected design with the second design.

At the operation 426, the design demonstration engine 314 operates to receive a user request for modifying a parameter of the design displayed within the boundary defined by the selected locations on the photograph. The parameter of the design represents a characteristic of the design of building materials. Examples of the design characteristic include a size, an orientation, and a skew angle of the building materials.

At the operation 428, upon the salesperson's request or selection at the operation 426, the design demonstration engine 314 operates to change the corresponding characteristic of the design based upon the modified parameter of the design.

At the operation 430, the design demonstration engine 314 operates to display the changed design within the boundary on the photograph.

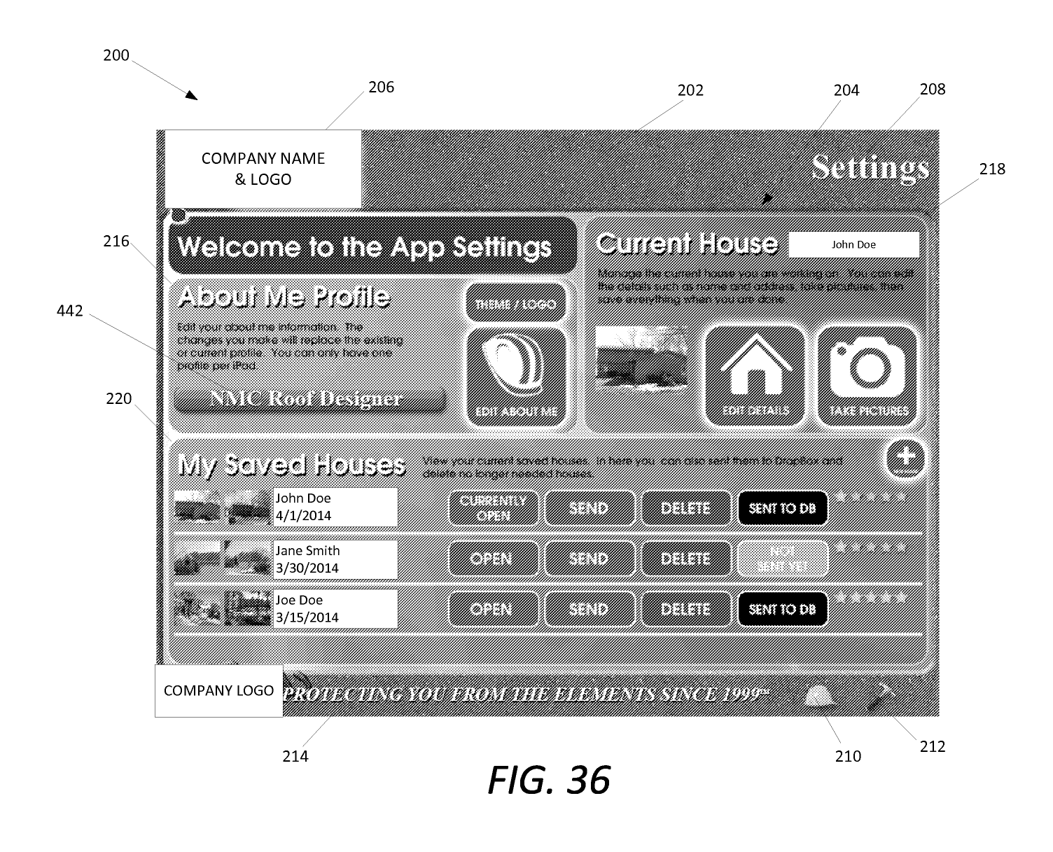

FIGS. 36-51 illustrate an example operation of the design demonstration engine 314.

FIG. 36 illustrates the main control screen 200 with a selectable control 442 for the design demonstration engine 314. In this example, the design demonstration engine 314 can be commenced when the salesperson selects the control 442 displayed on the main control screen 200. In some embodiments, the control 442 can also be displayed on one of the screens during the customized sales presentation 106.

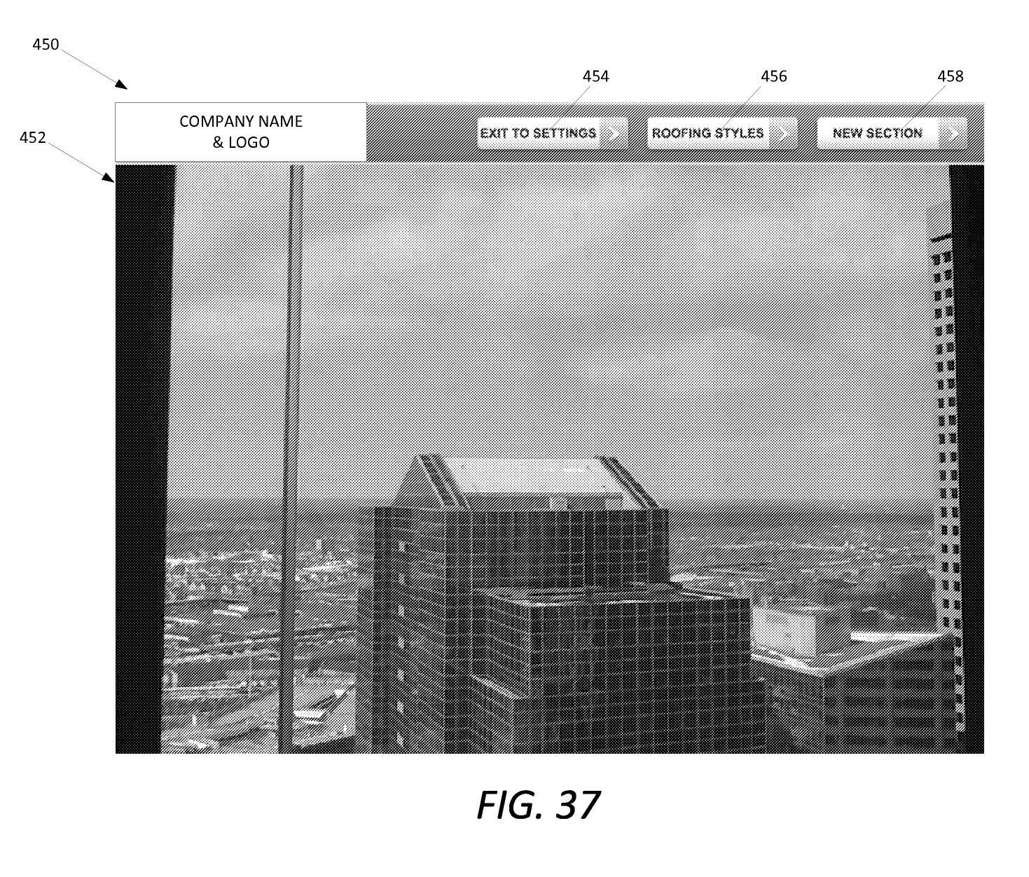

FIG. 37 illustrates an example design demonstration screen 450. In some embodiments, the design demonstration screen 450 includes a photograph display region 452, a save and exit control 454, a design option control 456, and a demonstration control 458.

The photograph display region 452 is configured to display a photograph of the subject building 92 used with the design demonstration engine 314. In some embodiments, a predetermined type of the photograph is selected for a particular demonstration purpose. For example, when the salesperson demonstrates different design options of roofing of the subject building, a photograph captured for a roof view by the photograph capture engine 236 can be displayed in the region 452.

The save and exit control 454 is a selectable control that the salesperson can select to store the photograph with any design updates and stop the design demonstration engine 314.

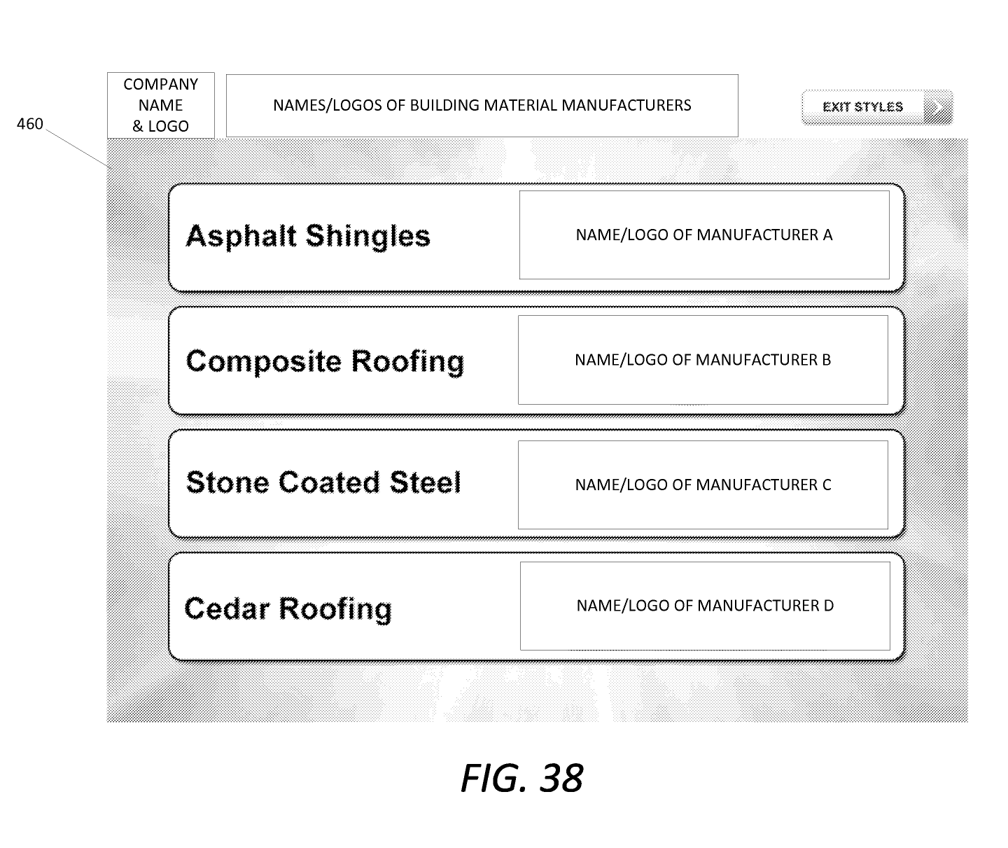

The design option control 456 is a selectable control that the salesperson can select to execute the design demonstration engine 314 to display a design option screen 460 (FIG. 38) configured to present different design options of building materials available for the subject building 92.

The demonstration control 458 is a selectable control that the salesperson can select to input a plurality of location selections to define a boundary on the displayed photograph.

FIG. 38 illustrates an example design option screen 460. The design option screen 460 operates to present different design options of building materials available for the subject building 92. In this example, the design option screen 460 is displayed when the salesperson selects the design option control 456 on the design demonstration screen 450. In some embodiments, the design option screen 460 includes selectable controls that the salesperson can select to navigate to other screens that present more design options of building materials. For example, the design options of building materials include different brands, styles, colors, patterns, materials, sizes of building materials.

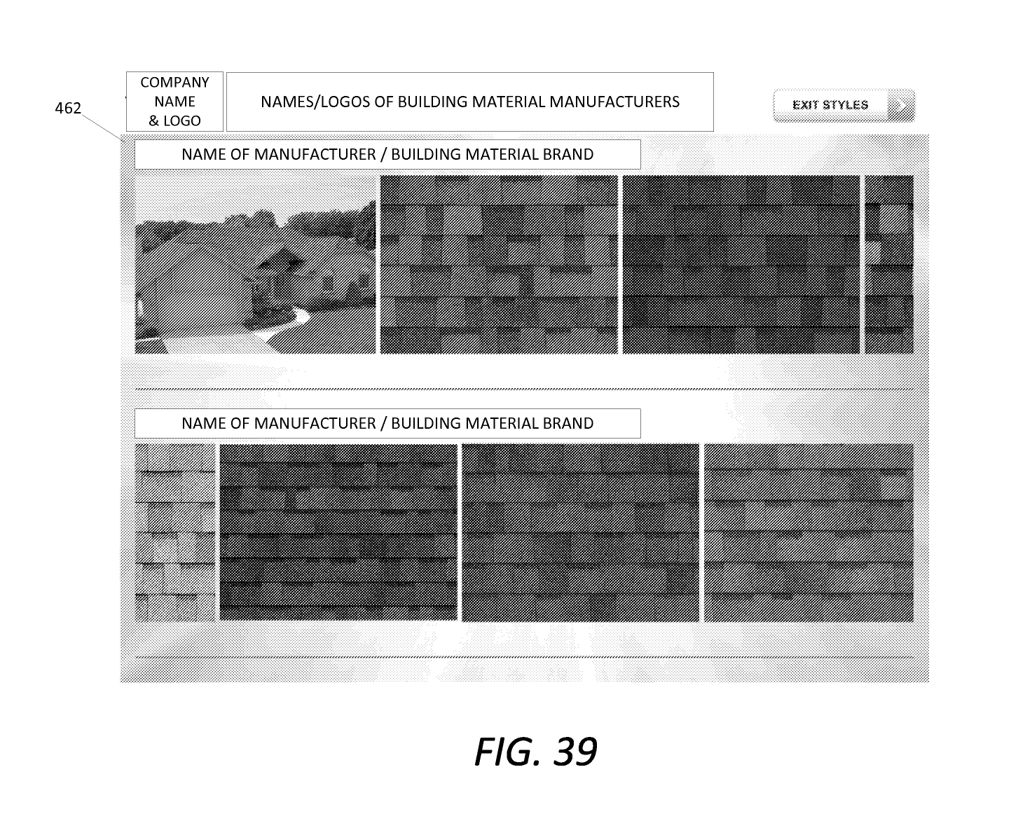

FIG. 39 illustrates an example design option sub-screen 462. When the salesperson selects one of the selectable controls on the design option screen 460, the design demonstration engine 314 operates to display the design option sub-screen 462 that contains design options of building materials and receives a user selection of one of the design options by the salesperson who interacts with the input device, such as the touch-sensitive display device.

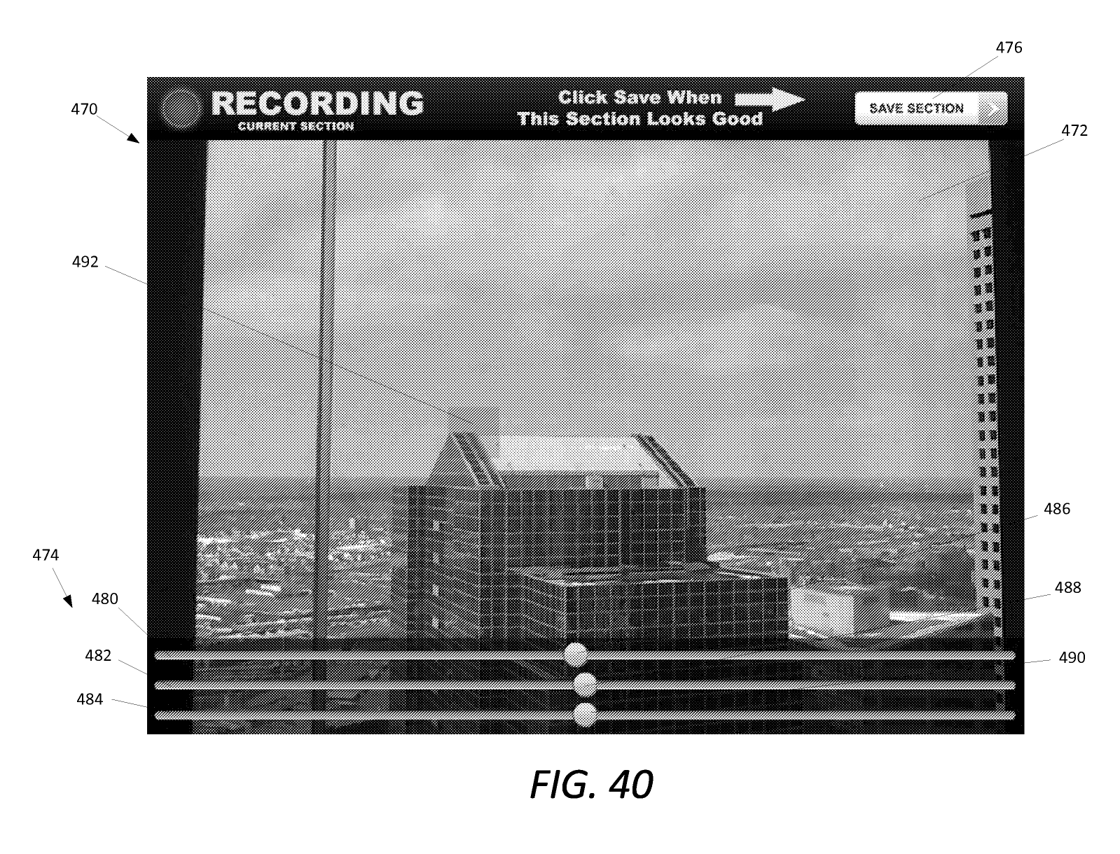

FIGS. 40-44 illustrate a process of defining a boundary on the photograph to which the selected design applies for demonstration purposes.

FIG. 40 illustrates an example design application screen 470. The design application screen 470 includes a photograph display region 472, a parameter adjustment control 474, and a save control 476.

The photograph display region 472 provides a region on which the predetermined photograph is displayed for design demonstration.

The parameter adjustment control 474 operates to adjust one or more parameters associated with characteristics of the selected building material design on the displayed photograph. In some embodiments, the parameter adjustment control 474 is configured to adjust a plurality of parameters of the selected building material design. In this example, the parameter adjustment control 474 includes three different parameter adjusters 480, 482 and 484. For example, a first parameter adjuster 480 is configured to change a first characteristic, such as a size, of the selected building material design. A second parameter adjuster 482 is configured to adjust a second characteristic, such as an orientation, of the selected building material design. A third parameter adjuster 484 is configured to change a third characteristic, such as a skew angle, of the selected building material design. The parameter adjusters 480, 482 and 484 include value indicators 486, 488 and 490 configured to indicate relative values of adjusted parameters, respectively. In the examples where the input device is a touch-sensitive display device, the value indicators 486, 488 and 490 are also used as user interfaces with which the salesperson interact to input desired adjustment to the parameters.

The save control 476 is a selectable control that the salesperson can select to store the displayed photograph with the selected building material design applied thereto, and exit the design demonstration engine 314.

As shown in FIG. 40, the salesperson inputs a first location selection, and the design demonstration engine 314 displays a first location, which corresponds to the first location selection, on the displayed photograph. In some embodiments, the first location is identified as a first visual indicator 492 on the photograph. In some embodiments where the input device is a touch-sensitive display device, the salesperson can select the first location by touching a desired position on the displayed photograph.

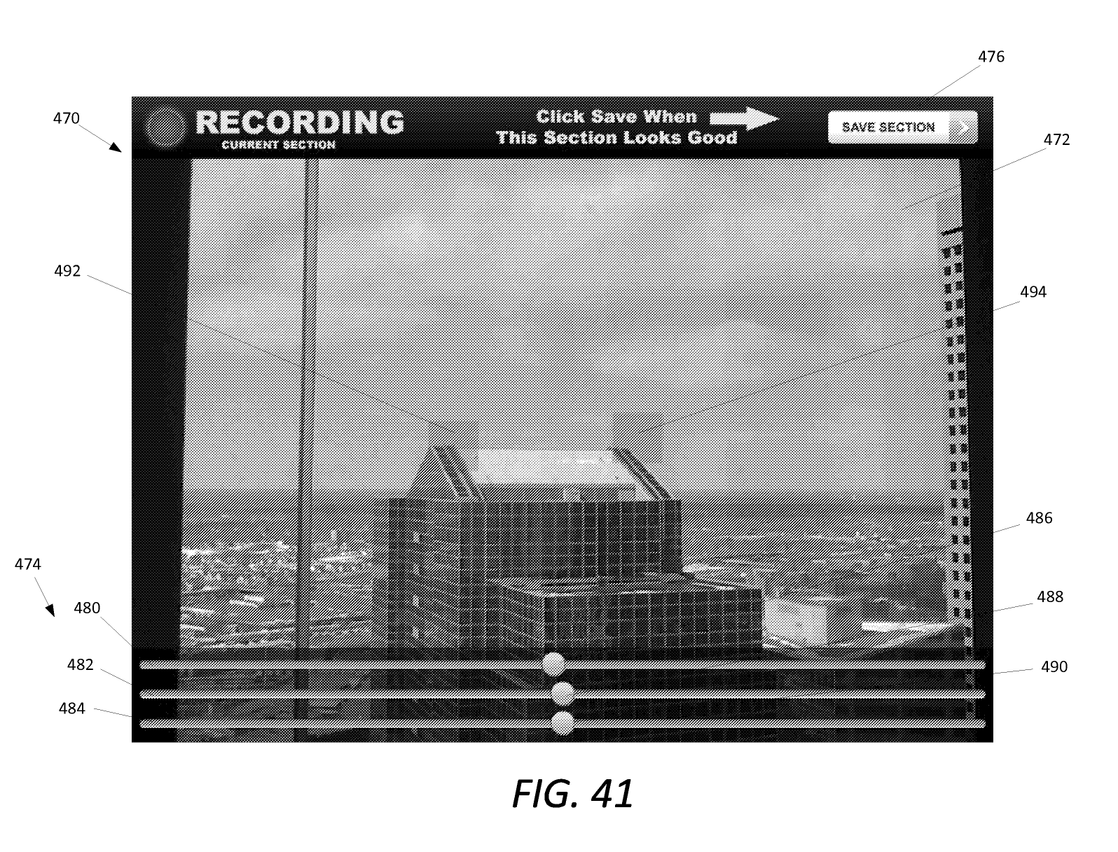

FIG. 41 illustrates the design application screen 470 with a second visual indicator 494. Similarly to FIG. 40, the salesperson inputs a second location selection through the input device, and the second location is shown as the second visual indicator 494 on the photograph.

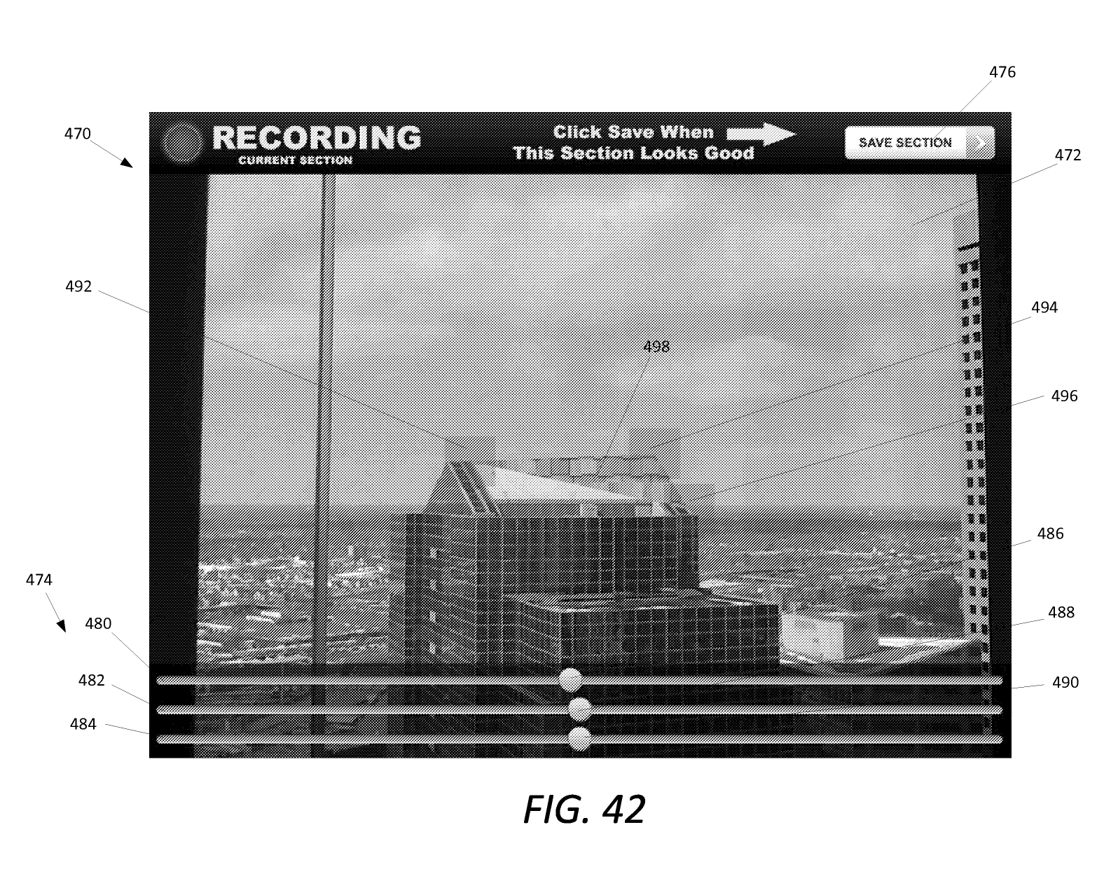

FIG. 42 illustrates the design application screen 470 with a third visual indicator 496. Similarly to FIGS. 40 and 41, the salesperson inputs a third location selection through the input device, and the third location is shown as the third visual indicator 496 on the photograph.

As shown in FIG. 42, the first, second, and third locations selected on the photograph form a closed boundary 498. In some embodiments, the design demonstration engine 314 displays the selected building material design within the boundary 498 on the photograph. The selected building material design overlays the displayed photograph within the boundary 498.

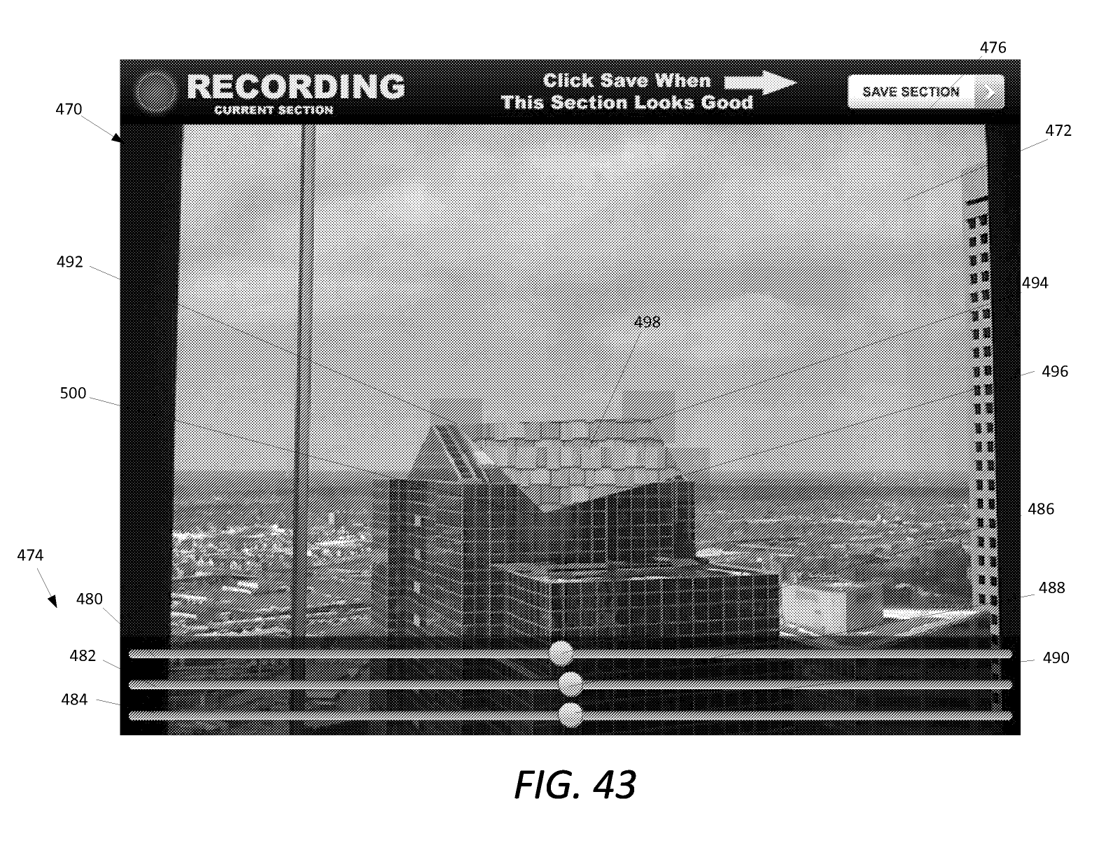

FIG. 43 illustrates the design application screen 470 with a fourth visual indicator 500. Similarly to FIGS. 40-42, the salesperson inputs a fourth location selection through the input device, and the fourth location is shown as the fourth visual indicator 500 on the photograph. The closed boundary 498 is still maintained with four locations, and the selected building material design is displayed within the boundary 498. In a similar manner, the salesperson can input more location selections through the input device, and the selected building material designed is applied to the boundary 498 defined by the plurality of the selected locations on the displayed photograph.

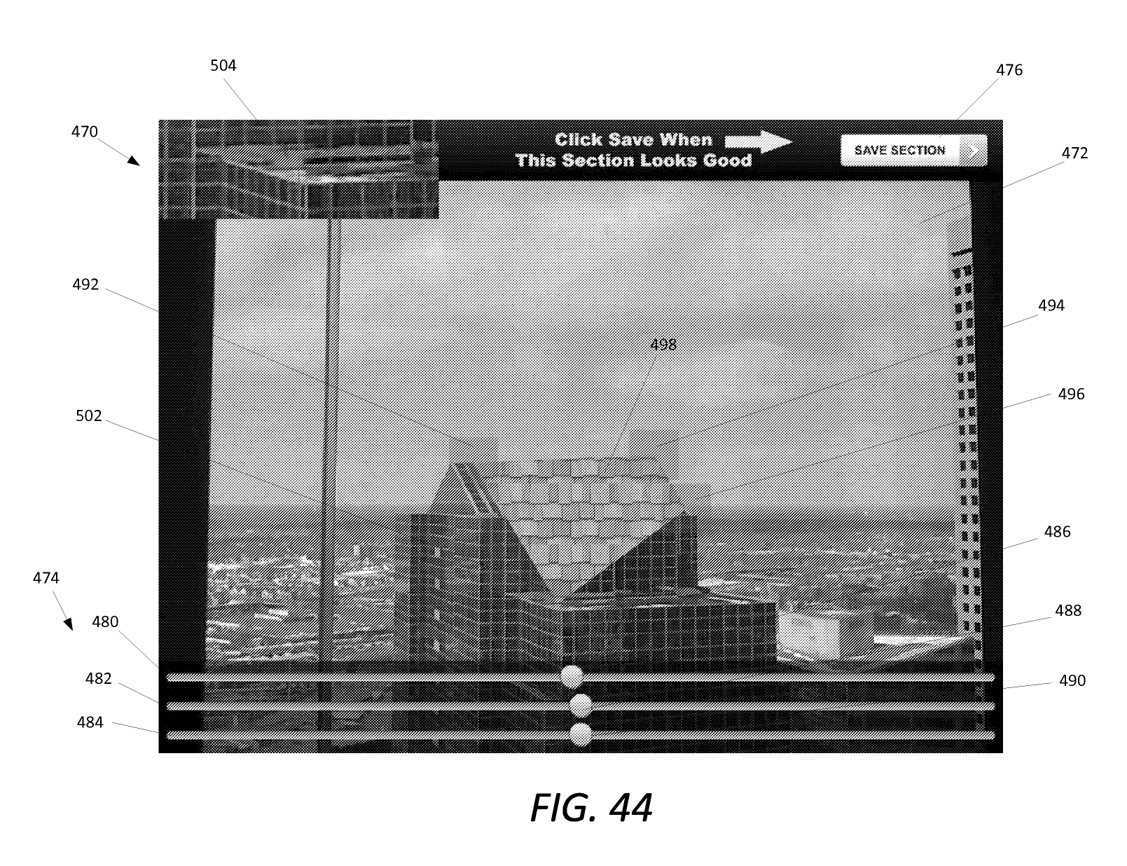

FIG. 44 illustrates the design application screen 470 with the fourth visual indicator 500 displaced to a new location 502. In some embodiments, the design demonstration engine 314 operates to change the locations selected by the salesperson. For example, the design demonstration engine 314 operates to detect a displacement request from the salesperson through the input device. Where the input device is a touch-sensitive display device, the displacement request can be the salesperson's touch interaction with the display device. Then, the design demonstration engine 314 operates to detect a new location selection by the salesperson through the input device. Where the input device is the touch-sensitive display device, the new location can be the salesperson's touch interaction with the display device. Finally, the design demonstration engine 314 replaces the original location with the new location and displays a new visual indicator. For example, as shown in FIG. 44, the new visual indicator 502 is displayed in replace with the original visual indicator 500.

In some embodiments, where the input device is the touch-sensitive display device, the design demonstration engine 314 operates to detect a touching event by the salesperson onto a visual indicator displayed on the display device, and detect a dragging event of the visual indicator by the salesperson on the display device. Based upon the dragging event, the design demonstration engine 314 operates to move the visual indicator along a path determined by the dragging event on the display device. The design demonstration engine 314 further operates to detect a ceasing event at a new location on the photograph, and then display the visual indicator at the new location on the photograph.

In some embodiments, the design demonstration engine 314 operates enlarge an area at and around the visual indicator and display the enlarged area 504 on the design application screen 470 during the dragging event. For example, as shown in FIG. 44, the area at and around the fourth visual indicator 502 is enlarged and displayed as the enlarged area 504 while the salesperson touches and drags the fourth visual indicator 502 on the displayed photograph.

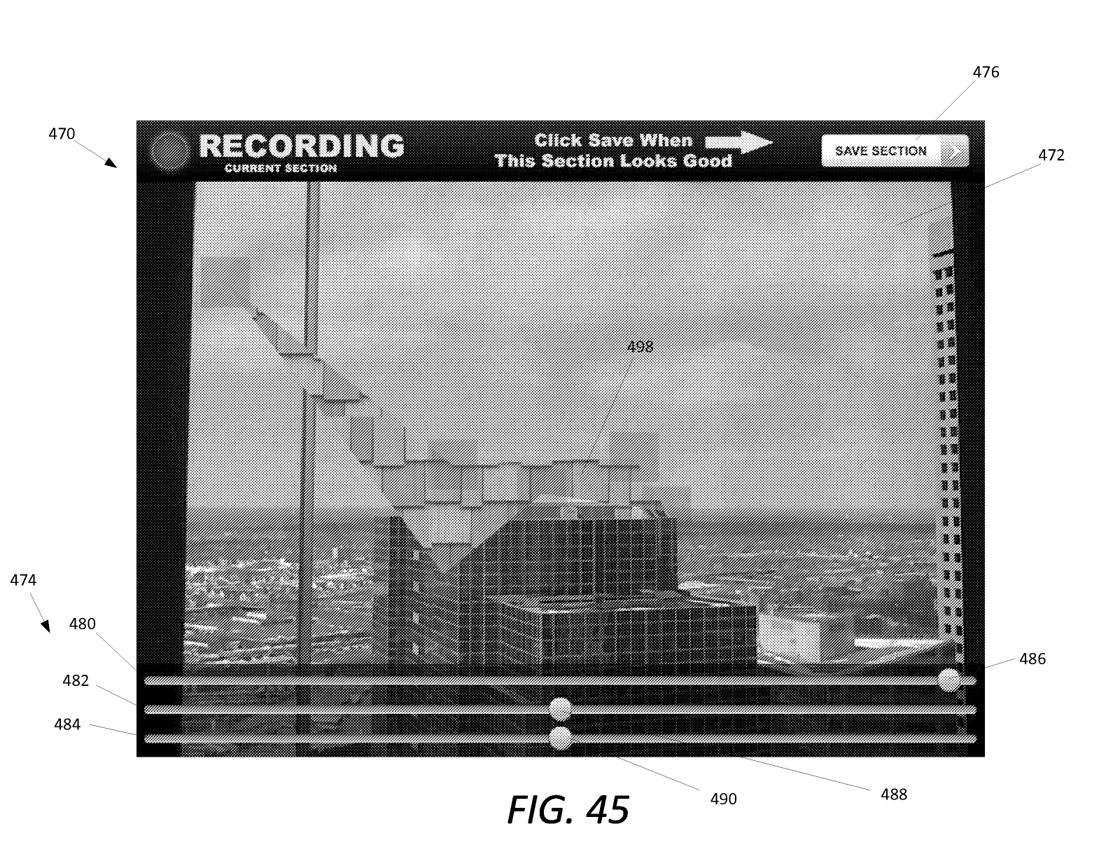

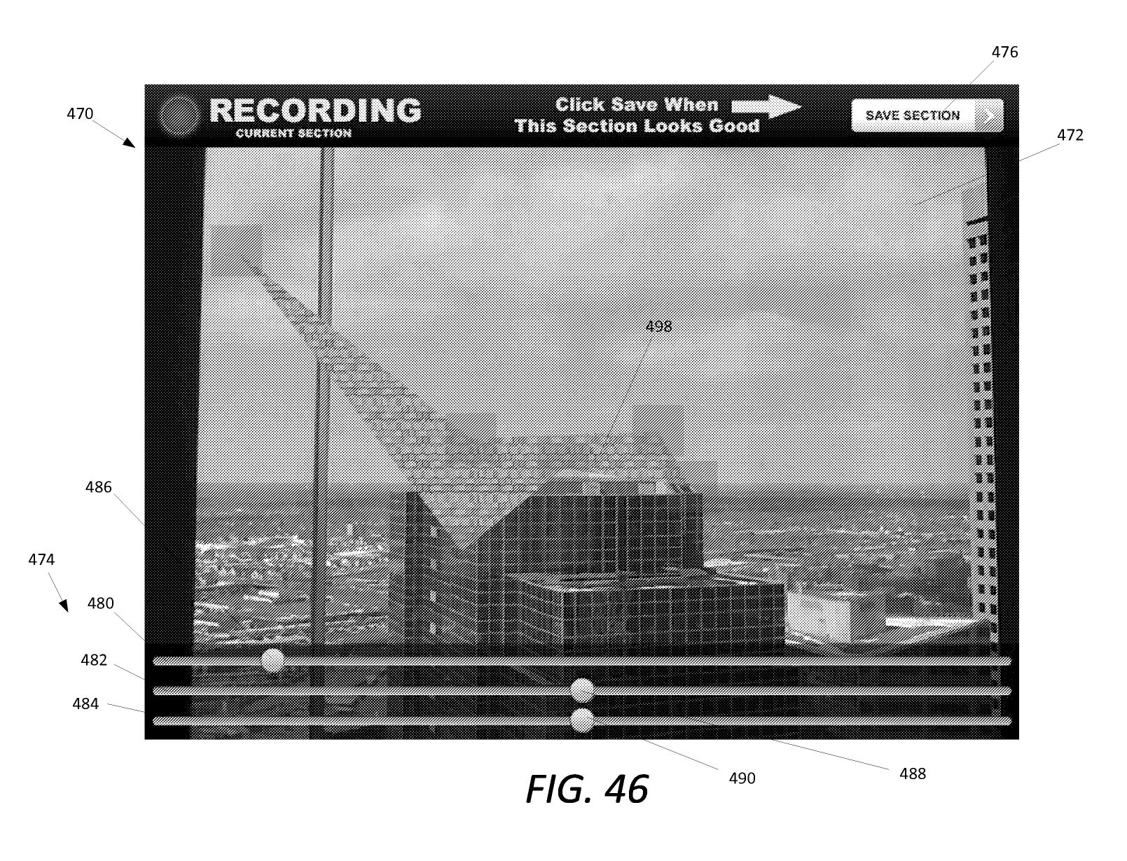

FIGS. 45 and 46 illustrate the design application screen 470 with a first parameter of the building material design adjusted. In this example, the first parameter represents the size of the building material design displayed within the boundary 498. As the salesperson adjusts the first parameter through the input device, the first value indicator 486 shifts right-to-left or vice versa along the first parameter adjuster 480, and the size of the design changes accordingly. Where the input device is a touch-sensitive display device, the salesperson can drag the first value indicator 486 along the first parameter adjuster 480 to change the value of the first parameter (the size).

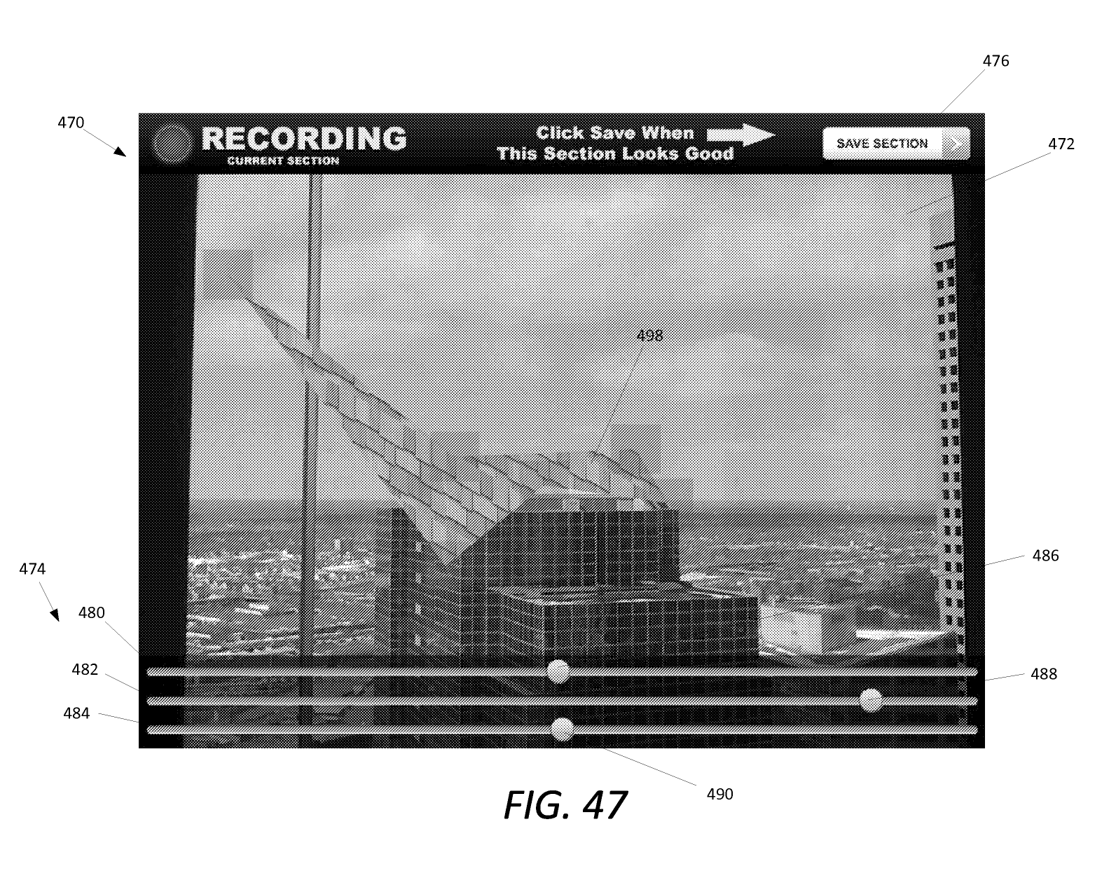

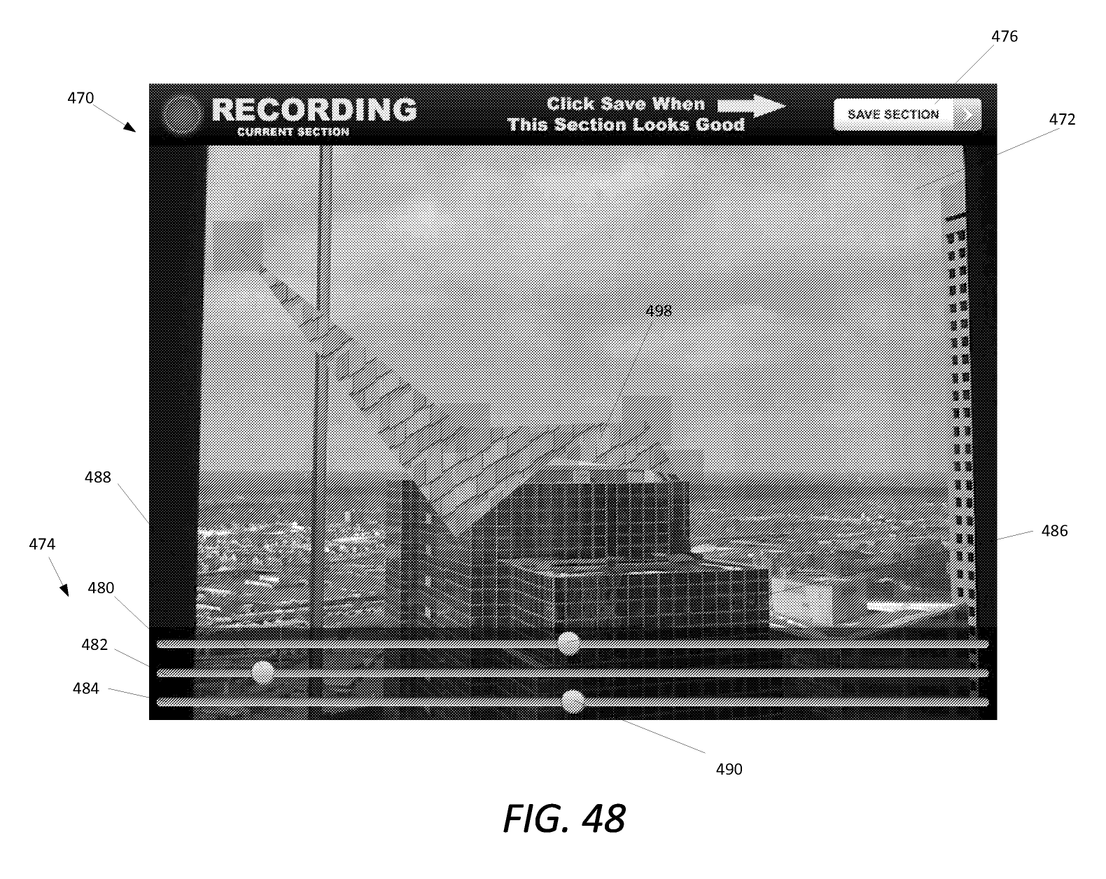

FIGS. 47 and 48 illustrate the design application screen 470 with a second parameter of the building material design adjusted. In this example, the second parameter represents the orientation of the building material design displayed within the boundary 498. The adjustment of the second parameter is similar to the first parameter adjustment as shown in FIGS. 45 and 46, the description thereof is omitted for brevity purposes.

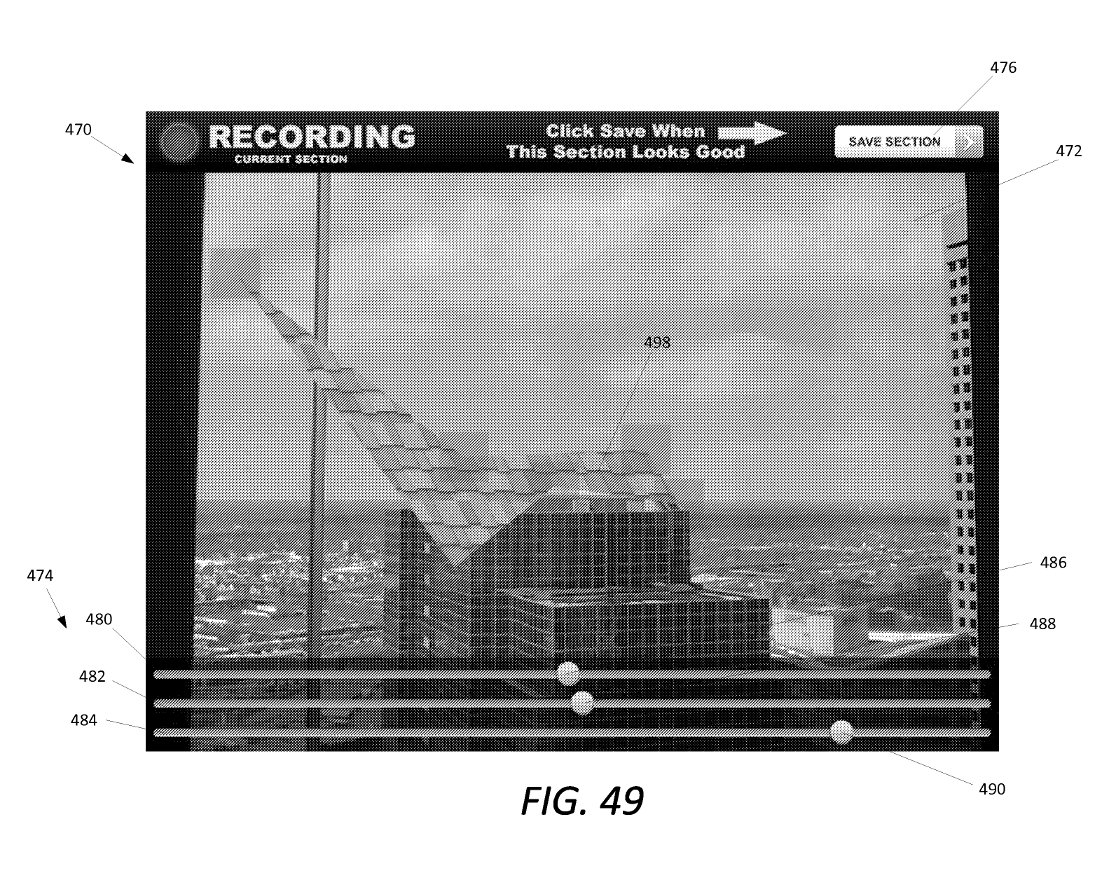

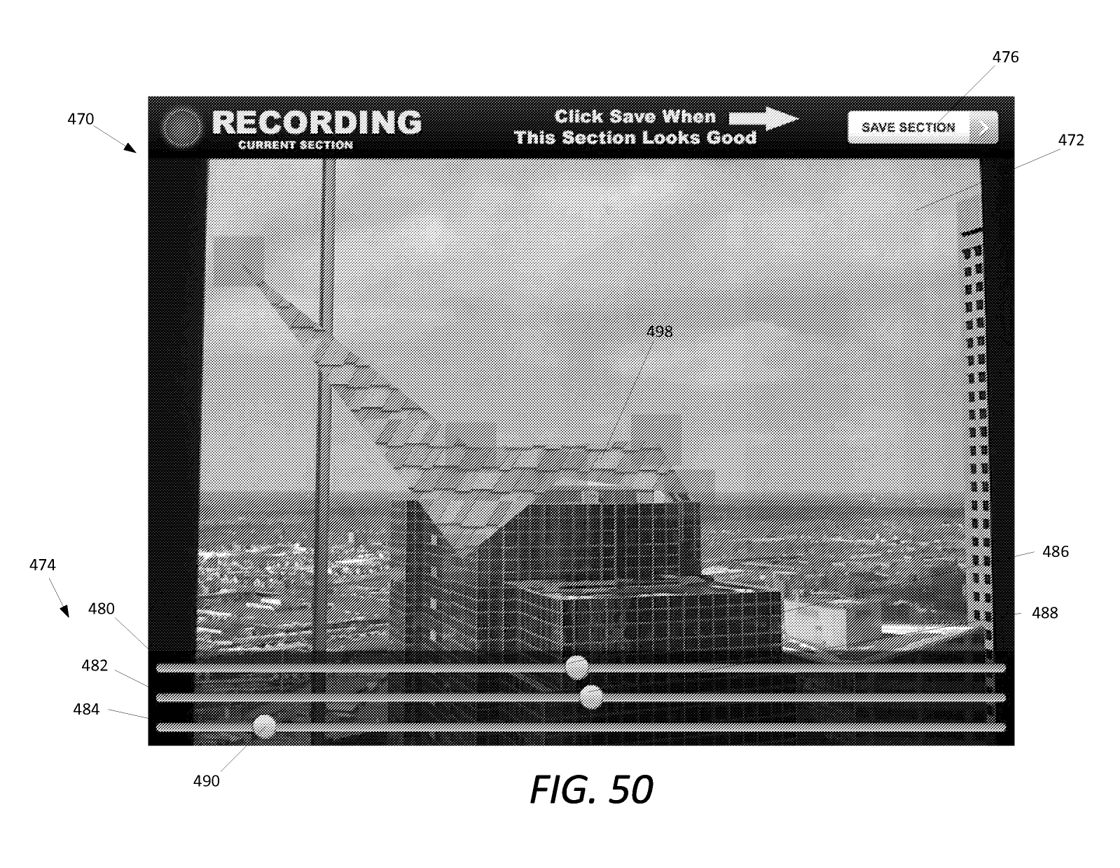

FIGS. 49 and 50 illustrate the design application screen 470 with a third parameter of the building material design adjusted. In this example, the third parameter represents the skew angle of the building material design displayed within the boundary 498. The adjustment of the third parameter is similar to the first parameter adjustment as shown in FIGS. 45 and 46, the description thereof is omitted for brevity purposes.

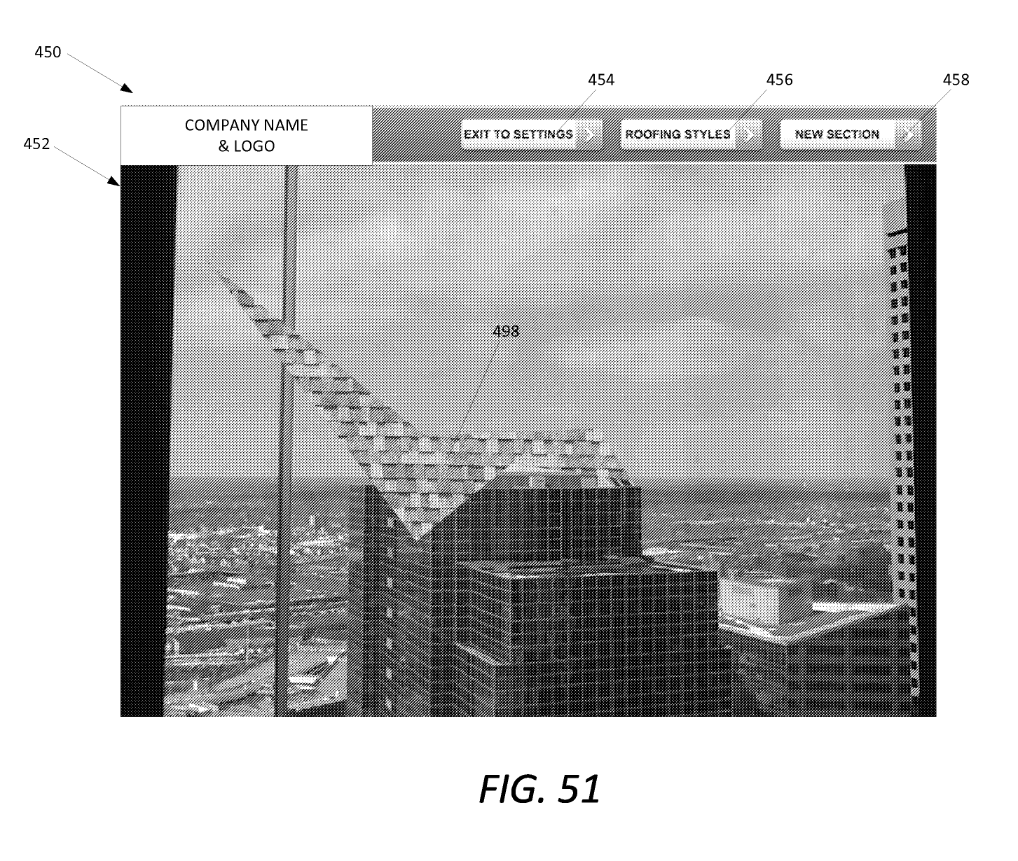

FIG. 51 illustrates the design demonstration screen 450 with another building material design. In some embodiments, the salesperson can change the design option of building material after the boundary 498 is defined and an originally selected design option of building material is applied to the boundary 498. For example, when the salesperson defines the boundary 498 on the design application screen 470, the originally selected design option is applied to the boundary 498 on the photograph. If the salesperson wants to apply a different design option afterwards, the salesperson can select a new design option by navigating the design option control 456. According to the new selection of the building material design option, the design demonstration engine 314 operates to replace the originally selected design option with the new selection and display the new design within the boundary 498 on the photograph.

FIG. 52 illustrates an example network communication system 510 of the on-site construction sales presentation system 100. The network communication system 510 includes the mobile computing device 102, one or more building material manufacturers 512, a construction contractor company 514, and a network 516. The construction contractor company 514 operates and manages a server computing device 518.

As described above, the mobile computing device 102 operates to perform the customized on-site sales presentation 106, as well as selectively interact with the construction contractor company 514 through the network 516. The customized on-site sales presentation 106, as described above, can be performed while the mobile computing device 102 is not connected to the server computing device 518 via the network 516. However, the mobile computing device 102 needs to be connected to the server computing device 518 for other purposes, as described below with reference to FIGS. 53 and 54.

The building material manufacturers 512 are entities that provide building materials to the construction contractor company 514 for construction work. In some embodiments, the building material manufacturers 512 provides information or data of building materials (e.g., the specifications of building materials) and/or manufacturer information to the construction contractor company 514 so that the construction contractor company 514 uses the information or data for preparing the customized sales presentation 106. As described above, the sales information contains the building material information that is supplied by the building material manufacturer 512. In some embodiments, the building material manufacturer 512 provides the building material information to the construction contractor company 514 through the network 516.

The construction contractor company 514 is an entity that provides construction service to customers. The construction contractor company 514 employs the on-site construction sales presentation system 100, and manages the customized sales presentation 106 and operates the server computing device 518. In some embodiments, the construction contractor company 514 hires salesperson or sales representatives who visit target customers at customers' sites 90 and give the customized sales presentation 106 with the mobile computing device 102 at the customers' sites 90.

The network 516 communicates digital data between one or more computing devices, such as between the mobile computing device 102 and the server computing device 518. Examples of the network 516 include a local area network and a wide area network, such as the Internet.

In some embodiments, the network 516 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or RF signals, and an optical or RF receiver for receiving optical or RF signals. Examples of wireless communication systems include Wi-Fi communication devices (such as utilizing wireless routers or wireless access points), cellular communication devices (such as utilizing one or more cellular base stations), and other wireless communication devices.

The server computing device 518 operates to interact with the mobile computing device 102. In some embodiments, the server computing device 518 provides various information and data to the mobile computing device 102 and receives customer-related information from the mobile computing device 102. Further, the server computing device 518 operates to provide an interface for the construction contractor company 514 to input information or instructions for the mobile computing device 102. In some embodiments, the construction contractor company 514 interacts with the mobile computing device 102 on personal computers or computing devices, such as desktop computers, laptops, smartphones, tablets and other hand-held devices.

In some embodiments, the construction contractor company 514 uses third-party content management systems (CMS's) (such as WordPress or any other publicly- and/or commercially-available content management systems) and third-party file hosting services (such as Dropbox, OneDrive, Google Drive, or any other publicly- and/or commercially-available file hosting services) to manage the on-site sales presentation engine 104 on the mobile computing device 102. The construction contractor company 514 can also use a web hosting service to manage and operate the server computing device 518. In other embodiments, the construction contractor company 514 can own, host, and operate the server computing device 518.

As marketing purposes, in some examples, the construction contractor company 514 can sell the mobile applications implemented by the on-sites sales presentation engine 104 through online application markets, such as App Store operated by Apple, Inc. and Google Play operated by Google Inc. The construction contractor company 514 can also collect payment for the mobile applications from purchasers through the online application markets. In some embodiments, the construction contractor company 514 manages verification codes that initiate and authorize purchasers to use the mobile applications.

FIG. 53 illustrates an example server communication engine 176. In some embodiments, the server communication engine 176 includes a network connection engine 522, a data transfer engine 524, and a user verification engine 526.

The network connection engine 522 operates to detect connection capability between the mobile computing device 102 and the server computing device 518 through the network 516. When the connection is available, the network connection engine 522 operates to establish communication between the mobile computing device 102 and the server computing device 518 via the network 516.

The date transfer engine 524 operates to transfer information or data stored in the mobile computing device 102 to the server computing device 518, and receives information or data from the server computing device 518. The information or data from the server computing device 518 includes, for example, updated sales information, temporary promotion information, and security information. In some embodiments, the information or data stored in the mobile computing device 102 are converted to a portable document format (PDF) and transferred to the server computing device 518.

The user verification engine 526 operates to verify that the salesperson is authorized by the construction contractor company 514 to use the on-site construction sales presentation system 100 on the mobile computing device 102. In some embodiments, the user verification engine 526 operates to receive security information from the salesperson, and compare the salesperson's security information with the security information received from the server computing device 518. If the user verification engine 526 determines that the salesperson's passcode does not match the security information provided by the server computing device 518, the user verification engine 526 disables the operation of the on-site sales presentation engine 104 on the mobile computing device 102.

In some embodiments, each on-site sales presentation engine 104 is configured to contain a unique identifier, such as a serial number or security passcode. In this case, the construction contractor company 514 can disable the operation of a particular on-site sales presentation engine 104 based upon the unique identifier of the engine 104. In other embodiments, the server computing device 518 operates to transmit a shut-down request for an on-site sales presentation engine 104 having a particular identifier, and the user verification engine 526 operates to disable the engine 104 based upon the shut-down request.

FIG. 54 illustrates the main control screen 200 with selectable controls for operating the data transfer engine 524. In some embodiments, the customer management region 220 includes a data transfer control 532 for each customer in the customer list. When the salesperson selects the data transfer control 532, the data transfer engine 524 operates to transfer the information or date associated with the corresponding customer to the server computing device 518. Once the data transfer is done, the data transfer engine 524 operates to change a transfer status indicator 534 to indicate the completion of the data transfer.

FIG. 55 illustrates an example application branding engine 178. The application branding engine 178 operates to prompt the salesperson to brand the customized sales presentation 106 for a particular company. Examples of branding include the importing and arrangement of a company name and/or log into the customized sales presentations 106, and adjustment of the color scheme or other ornamental features of the customized sales presentation 106.

In some embodiments, the application branding engine 178 operates to receive a user request for customizing a layout displayed on the screen. Upon the request, the application branding engine 178 operates to present a plurality of options for characteristics of the layout. The salesperson can select one of the options, and the application branding engine 178 operates to receive the selection of the option through the input device. Then, the application branding engine 178 operates to modify the corresponding characteristic of the layout according to the selected option. Examples of the characteristics of the layout include a logo, a theme, a template, a background color, a background photograph, and an arrangement of information on the display screen.

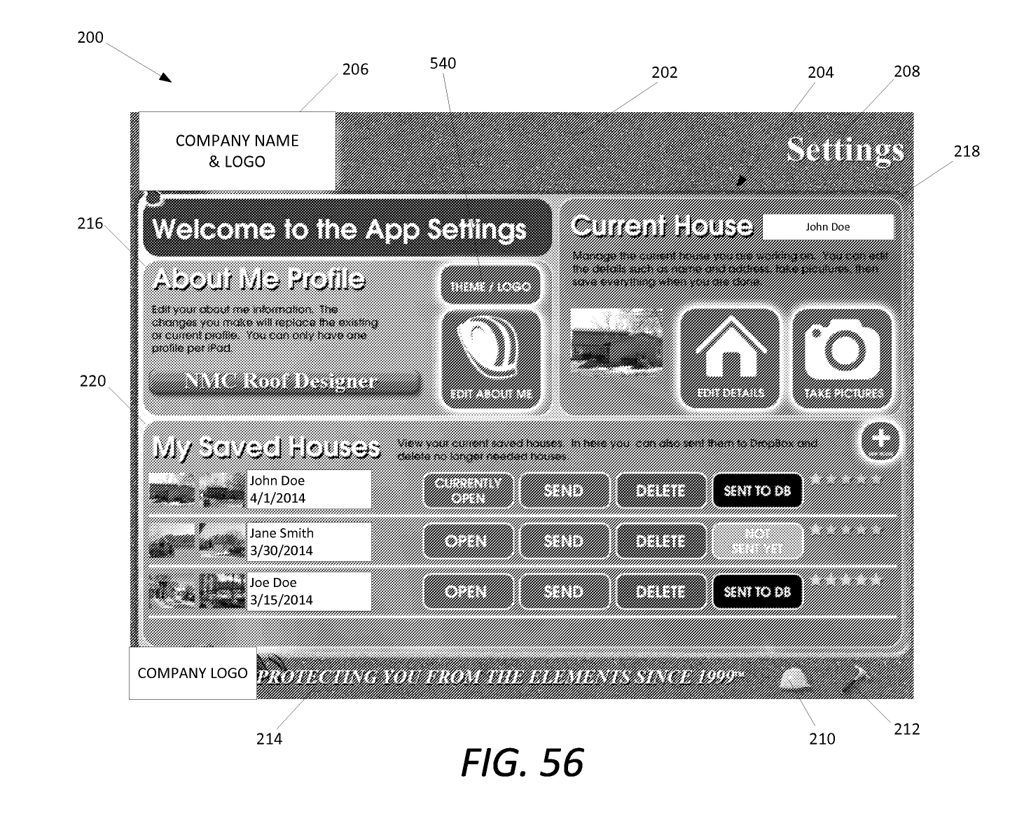

FIG. 56 illustrates the main control screen 200 with a branding control 540. In some embodiments, the application branding engine 178 is initiated by selecting the branding control 540.

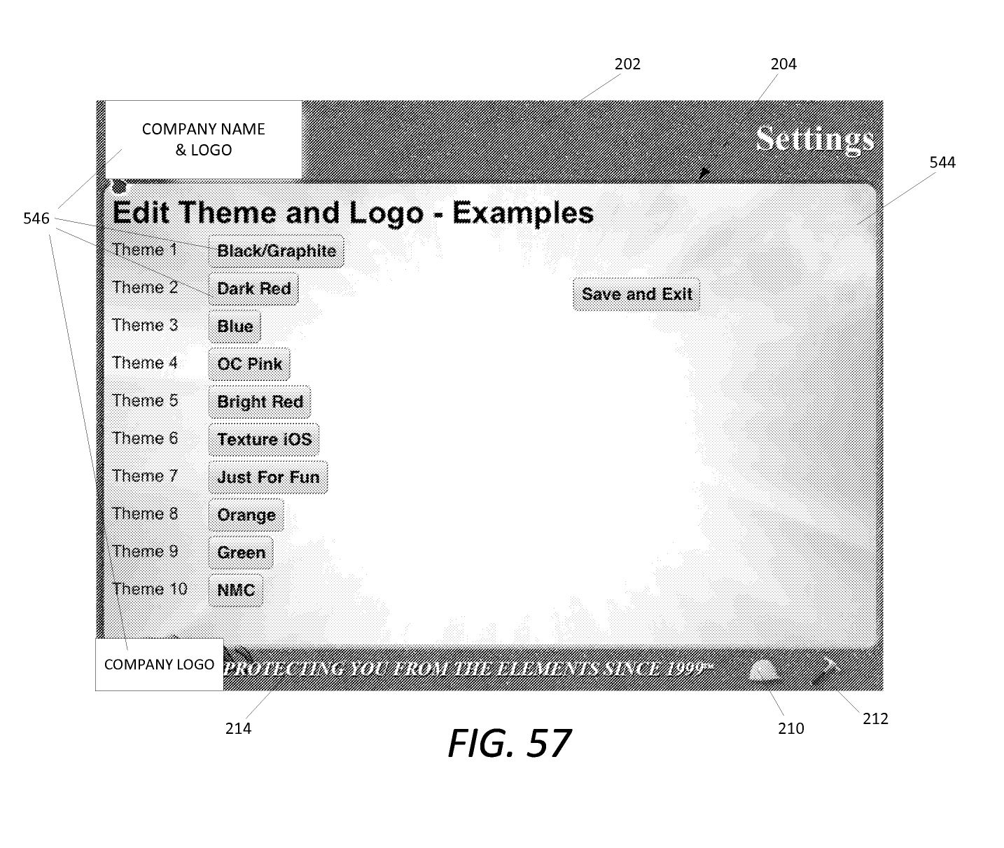

FIG. 57 illustrates an example branding screen 544. The branding screen 544 provides selectable controls that the salesperson can select to change different characteristics of the customized sales presentation 106. In this example, the branding screen 544 provides selectable controls 546 for changing a layout theme and a company logo of the layout of the customized sales presentation 106. When the salesperson selects one of the controls 546, the application branding engine 178 changes the theme and/or the company logo of the sales presentation 106.

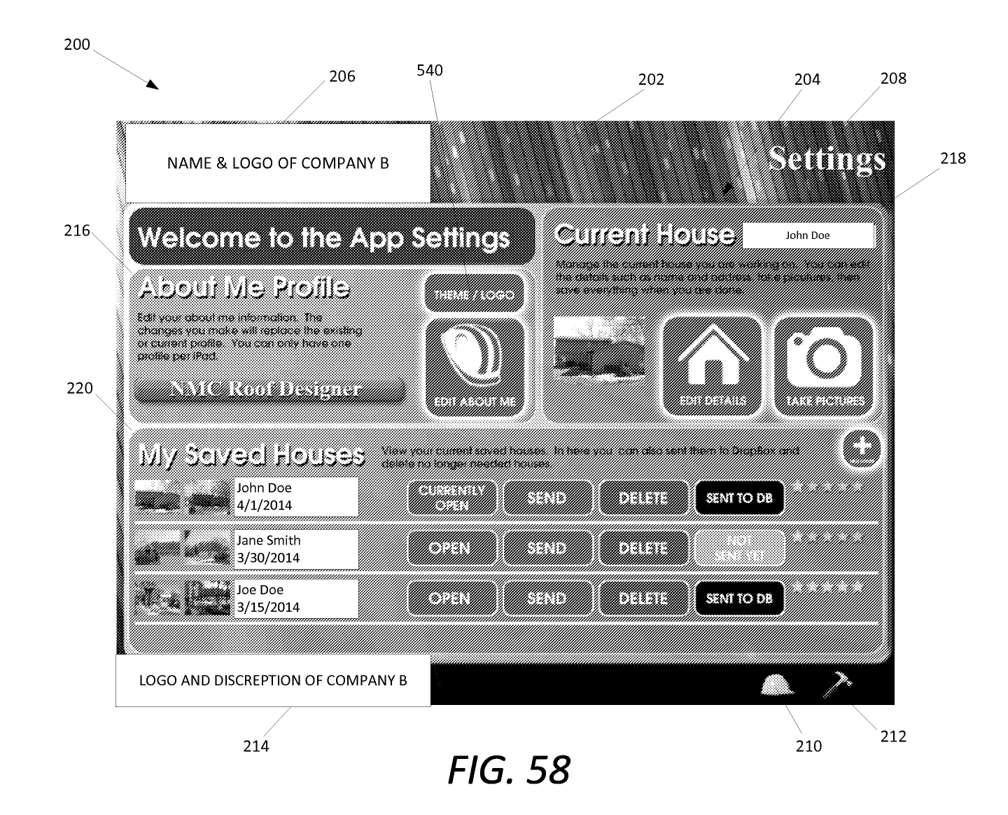

FIG. 58 illustrates the main control screen 200 with a different theme and company name/logo. According to the selection of branding options, the application branding engine 178 operates to replace the corresponding characteristics of the sales presentation 106 with the selected branding option. In the depicted example, the template frame 202, the company identifier 206, and the additional information region 214 are modified in accordance with the salesperson's selection of branding options.

The present disclosure refers to example screens that are generated by a sales presentation engine 104. A screen is a graphical display generated by the sales presentation engine 104, such as displayed on a display device of the mobile computing device 102. The screens can be a user interface generated by a software application, a web page display generated by a Web browser, a window, or a variety of other possible displays.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1-20. (canceled)

21. A method for creating and presenting a customized in-home construction sales presentation, the method comprising:
accessing a sales presentation having a plurality of sales presentation slides via a mobile computing device having a camera;
taking one or more photographs of a subject building with the mobile computing device camera;
customizing the construction sales presentation by adding at least one of the one or more photographs to at least one of the presentation slides;
customizing the construction sales presentation by adding one or both of contractor-specific information and building owner-specific information to at least one of the presentation slides;
customizing the number of slides to be included in the customized sales presentation by selecting a subset of the sales presentation slides;
presenting the customized construction sales presentation by displaying the customized construction sales presentation on a display screen of the mobile computing device; and
transmitting the customized construction sales presentation to a location remote from the mobile computing device.

22. The method of claim 21, further comprising:
receiving, using the mobile computing device, a user selection for adding information to at least one of the sales presentation slides.

23. The method of claim 22, wherein receiving a user selection includes:
receiving, using the mobile computing device, a user selection of customizing a layout of at least one of the slides in the customizable construction sales presentation, the layout including at least one characteristic, the at least one characteristic including at least one of a logo, a company name, editable text, an image or video file from a library, a theme, a template, a background color, a background photograph, and an arrangement of information on the at least one of the slides; and
modifying the layout of the at least one of the slides based on the user selection.

24. The method of claim 23, wherein at least one of the slides includes contractor-specific information.

25. The method of claim 21, wherein at least one of the slides includes salesperson-specific information.

26. The method of claim 24, further comprising:
receiving, using the mobile computing device, a logo image file, the logo image file storing a contractor logo; and
displaying the contractor logo and a company name at a predetermined location on at least one of the slides in the customizable construction sales presentation.

27. The method of claim 24, further comprising:
receiving, using the mobile computing device, a user selection for a color scheme, the color scheme including at least one color; and
applying the at least one color in at least one predetermined area on at least one of the slides in the customizable construction sales presentation.

28. The method of claim 21, wherein generating a customizable construction sales presentation includes:
generating, using the mobile computing device, at least one roof design slide, the at least one roof design slide including information of a plurality of roof materials available for the subject building, the at least one roof design slide included in the customizable roof construction sales presentation.

29. The method of claim 21, wherein generating a customizable construction sales presentation includes:
generating, using the mobile computing device, at least one warranty slide, the at least one warranty slide including information about warranty options, the at least one warranty slide included in the customizable roof construction sales presentation.

30. The method of claim 21, wherein generating a customizable construction sales presentation includes:
generating, using the mobile computing device, at least one home and/or business restoration insurance information slide, the at least one home and/or business restoration insurance information slide including information about home and/or business restoration insurance claim work, the at least one home and/or business restoration insurance information slide included in the customizable roof construction sales presentation.

31. The method of claim 21, wherein generating a customizable roof construction sales presentation includes:
generating, using the mobile computing device, at least one promotion slide, the at least one promotion slide including at least one of information about awards won by a company, information about a letter of recommendation, information about customer review, information about community involvement, a video about a company, a video of customer testimonials, and information about environmentally-friendly products.

32. The method of claim 21, further comprising:
receiving, using the mobile computing device, a user selection for uploading at least portion of the customizable roof construction sales presentation; and
transmitting the at least portion of the customizable construction sales presentation from the at least one computing device to a server computing device.

33. The method of claim 21, wherein at least some steps of the method are performed while being disconnected to a data communication network.

34. A computer-readable storage medium comprising software instructions that, when executed by at least one computing device, cause the at least one computing device to:
receive a user selection from a salesperson for capturing one or more photographs of a subject building at a first location;
execute a camera device to interact with the salesperson to capture the one or more photographs of the subject building at the first location;
generate a customizable roof construction sales presentation, the customizable roof construction sales presentation including one or more slides, at least one of the slides including customer-specific information and at least one of the one or more photographs of the subject building; and
display the customizable roof construction sales presentation on a display screen of the at least one computing device.

35. The computer-readable storage medium of claim 34, wherein the software instructions, when executed, further cause the at least one computing device to:
receive a user selection for customizing at least one of the slides in the customizable roof construction sales presentation.

36. The computer-readable storage medium of claim 34, wherein the software instructions, when executed, further cause the at least one computing device to:
receive a user selection of customizing a layout of at least one of the slides in the customizable roof construction sales presentation, the layout including at least one characteristic, the at least one characteristic including at least one of a logo, a company name, editable text, an image or video file from a library, a theme, a template, a background color, a background photograph, and an arrangement of information on the at least one of the slides; and
modify the layout of the at least one of the slides based on the user selection.

37. The computer-readable storage medium of claim 34, wherein at least one of the slides includes contractor-specific information.

38. The computer-readable storage medium of claim 34, wherein the software instructions, when executed, further cause the at least one computing device to:
receive a logo image file, the logo image file storing a contractor logo; and
display the contractor logo and a company name at a predetermined location on at least one of the slides in the customizable roof construction sales presentation.

39. The computer-readable storage medium of claim 34, wherein the software instructions, when executed, further cause the at least one computing device to:
receive a user selection for a color scheme, the color scheme including at least one color; and
apply the at least one color in at least one predetermined area on at least one of the slides in the customizable roof construction sales presentation.

40. The computer-readable storage medium of claim 34, wherein the software instructions, when executed, further cause the at least one computing device to:
generate at least one roof design slide, the at least one roof design slide including information of a plurality of roof materials available for the subject building, the at least one roof design slide included in the customizable roof construction sales presentation.

41. The computer-readable storage medium of claim 34, wherein the software instructions, when executed, further cause the at least one computing device to:
generate at least one warranty slide, the at least one warranty slide including information about warranty options, the at least one warranty slide included in the customizable roof construction sales presentation.

42. The computer-readable storage medium of claim 34, wherein the software instructions, when executed, further cause the at least one computing device to:
generate at least one home and/or business restoration insurance information slide, the at least one home and/or business restoration insurance information slide including information about home and/or business restoration insurance claim work, the at least one home and/or business restoration insurance information slide included in the customizable roof construction sales presentation.

43. The computer-readable storage medium of claim 34, wherein the software instructions, when executed, further cause the at least one computing device to:
generate at least one promotion slide, the at least one promotion slide including at least one of information about awards won by a company, information about a letter of recommendation, information about customer review, information about community involvement, a video about a company, a video of customer testimonials, and information about environmentally-friendly products.

44. The computer-readable storage medium of claim 34, wherein the software instructions, when executed, further cause the at least one computing device to:
receive a user selection for uploading at least portion of the customizable roof construction sales presentation; and
transmit the at least portion of the customizable roof construction sales presentation from the at least one computing device to a server computing device.

45. A computer-readable storage medium comprising software instructions that, when executed by a server computing device and a mobile computing device, cause the server computing device and the mobile computing device to:
store data input by a user that relates to the customizable sales presentation on the server computing device via a web hosting service;
establish communication between the server computing device and the mobile computing device such that the data can be transferred from the server computing device to the mobile computing device and from the mobile computing device to the server computing device;
generating a customizable construction sales presentation based on the data transferred to the mobile computing device from the server computing device to assist a user in conducting a sales presentation to a customer at a customer location, wherein the customizable construction sales presentation includes one or more slides and at least one of the slides includes construction sales information;
receive a user selection for customizing at least one of the slides in the customizable construction sales presentation at the mobile computing device;
modify, at the mobile computing device, the at least one of the slides based on the user selection for customizing;
receive, at the mobile computing device, a user selection for initiating the customizable roof construction sales presentation at the customer site; and
receive, at the mobile computing device, a user request to navigate between at least two of the slides in the customizable roof construction sales presentation.

46. The computer-readable storage medium of claim 45, wherein the software instructions, when executed, further cause the mobile and server computing devices to:
receive, at the mobile computing device, a user selection for uploading at least portion of the customizable construction sales presentation to the server computing device; and
transmit a PDF version of the customizable construction sales presentation to a location external of the mobile computing device.

47. The computer-readable storage medium of claim 45, wherein the software instructions, when executed, further cause the mobile and server computing devices to:
receive a user verification code; and
verify, based on the user verification code, that the user is authorized to customize at least one of the slides in the customizable roof construction sales presentation.

48. The computer-readable storage medium of claim 45, wherein the software instructions, when executed, further cause the mobile and server computing devices to:
import a digital image file taken by a camera of the mobile computing device into the customizable sales presentation, the digital image file storing a photograph of a roof of a subject building;
modify a pitch or skew angle of the photograph to match a pitch or skew angle of the roof of the subject building; and
display the modified photograph of the subject building on at least one of the slides in the customizable roof construction sales presentation.

49. The computer-readable storage medium of claim 45, wherein the software instructions, when executed, further cause the mobile and server computing devices to:
enable a user to present the customizable roof construction sales presentation on the mobile computing device while being disconnected from the server computing device.

50. The computer-readable storage medium of claim 45, wherein the software instructions, when executed, further cause the mobile and server computing devices to:
generate at least one roof design slide, the at least one roof design slide including information of a plurality of roof materials available for the subject building, the at least one roof design slide included in the customizable roof construction sales presentation;
generate at least one warranty slide, the at least one warranty slide including information about warranty options, the at least one warranty slide included in the customizable roof construction sales presentation;
generate at least one home and/or business restoration insurance information slide, the at least one home and/or business restoration insurance information slide including information about home and/or business restoration insurance claim work, the at least one home and/or business restoration insurance information slide included in the customizable roof construction sales presentation; and
generate at least one promotion slide, the at least one promotion slide including at least one of information about awards won by a company, information about a letter of recommendation, information about customer review, information about community involvement, a video about a company, a video of customer testimonials, and information about environmentally-friendly products.
